(19) United States
(12) Patent Application Publication
(10) Pub. No.: US 2015/0106578 A1
(43) Pub. Date: Apr. 16, 2015

(54) SYSTEMS, METHODS AND DEVICES FOR IMPLEMENTING DATA MANAGEMENT IN A DISTRIBUTED DATA STORAGE SYSTEM

(71) Applicant: COHO DATA INC., San Jose, CA (US)

(72) Inventors: Andrew Warfield, Vancouver (CA); Jacob Taylor Wires, Vancouver (CA); Stephen Frowe Ingram, Vancouver (CA)

(21) Appl. No.: 14/514,729

(22) Filed: Oct. 15, 2014

Related U.S. Application Data
(60) Provisional application No. 61/891,159, filed on Oct. 15, 2013.

(51) Int. Cl. G06F 3/06

(52) U.S. Cl. CPC G06F 3/0613; G06F 3/0631; G06F 3/067
USPC 711/158

(57) ABSTRACT

Systems, methods and devices for monitoring data transactions in a data storage system, the data storage system being in network communication with a plurality of storage resources and comprising at least a data analysis module and a logging module, and receiving at the data analysis module at least one data transaction for data in the data storage system, each data transaction having at least one data-related characteristic; storing in the logging module the at least one data-related characteristic and a data transaction identifier that relates the data transaction to the associated at least one data-related characteristic in the logging module; analyzing at the data analysis module at least one data-related characteristic related to a first data transaction to determine if the first data transaction shares at least one data-related characteristic with other data transactions; and, in cases where the first data transaction shares at least one data-related characteristic with at least one other data transaction, logically linking the first data transaction with the other data transactions.

### FIELD OF THE DISCLOSURE

The present disclosure relates to data storage systems, and, in particular, to systems, methods and devices for implementing data management in distributed data storage systems.

### BACKGROUND

Among other drawbacks, enterprise storage targets can be very expensive. They can often represent an estimated 40% of capital expenditures on a new virtualization deployment (the servers and software licenses combine to form another 25%), and are among the highest-margin components of capital expenditure in enterprise IT spending. Enterprise Storage Area Networks (SANs) and Network Attached Storage (NAS) devices, which are typically utilized as memory resources for distributed memory systems, are very expensive, representing probably the highest margin computer hardware available in a datacenter environment.

Some systems, such as Veritas™'s cluster volume manager (to name just one), attempt to mitigate this cost by consolidating multiple disks on a host and or aggregated disks within a network to provide the appearance of a single storage target. While many such systems perform some degree of consolidating memory resources, they generally use simple, established techniques to unify a set of distributed memory resources into a single common pool. They provide little or no differentiation between dissimilar resource characteristics, and provide little or no application- or data-specific optimizations with regard to performance. Put simply, these related systems strive for the simple goal of aggregating distributed resources into the illusion of a single homogenous resource.

Managing the storage of data (documents, databases, email, and system images such as operating system and application files) is generally a complex and fragmented problem in business environments today. While a large number of products exist to manage data storage, they tend to take piecewise solutions at individual points across many layers of software and hardware systems. The solutions presented by enterprise storage systems, block devices or entire file system name spaces, are too coarse grained to allow the management of specific types of data (e.g. “All office documents should be stored on a reliable, high-performance, storage device irrespective of what computer they are accessed from”). It is difficult or impossible to specify other fine-grained (i.e. per-file, per-data object, per-user/client, e.g.) policies that utilize the priority, encryption, durability, throughput or performance properties of data, and then associating these properties of specific data objects with the optimal storage resources available across a storage system that in one way or another aggregates multiple storage resources. In particular, this becomes more complex when the data characteristics or the storage resource characteristics are continually in flux over time.

The placement of data in many known systems is explicit. Conventional approaches to storage, such as RAID and the erasure coding techniques that are common in object storage systems involve an opaque statistical assignment that tries to evenly balance data across multiple devices. This approach is fine if you have large numbers of devices and data that is accessed very uniformly. It is less useful if, as in the case of PCIe flash, you are capable of building a very high-performance system with even a relatively small number of devices or if you have data that has severe hot spots on a subset of very popular data.

Storage systems have always involved a hierarchy of progressively faster media, and there are a set of very well established techniques for attempting to keep hot data in smaller, faster memories. In general, storage system design has approached faster media from the perspective that slow disks represent primary storage, and that any form of faster memory (frequently DRAM on the controller, but more recently also flash-based caching accelerator cards) should be treated as cache. As a result, the problem that these systems set out to solve is how to promote the hottest set of data into cache, and how to keep it there in the face of other, lower-frequency accesses. Because caches have historically been much smaller than the total volume of primary storage, this has been a reasonable tactic: it is impractical to keep everything in cache all the time, and so a good caching algorithm gets the most value out of caching the small, but hottest subset of data.

The economics of high-performance flash suggest a different approach to designing storage systems. Given that PCIe flash is about a thousand times faster in terms of both throughput and latency than random access to a spinning disk, all hot data should now reside in flash. Unfortunately, known dynamic tiering and/or caching techniques remain in the previous paradigm. This, in addition to or in combination with the dearth of data management techniques for dynamically assigning data to the most appropriate type of available storage resources, based on whether the operational characteristics match the data requirements, as well as the limited ability to efficiently or accurately identify the temperature of data in prior or during its use, means that conventional data management techniques for distributed data storage systems is limited.

In known network switches, deciding where to send writes in order to distribute load in a distributed system has been challenging; techniques such as uniform hashing have been used to approximate load balancing. In all of these solutions, requests have to pass through a dumb switch which has no information relating to the distributed resources available to it and, moreover, complex logic to support routing, replication, and load-balancing becomes very difficult since the various memory resources must work in concert to some degree to understand where data is and how it has been treated by other memory resources in the distributed hosts.

Storage may be considered to be increasingly both expensive and underutilized. PCIe flash memories are available from numerous hardware vendors and range in random access throughput from about 50K to about 1M Input/Output Operations per Second (“IOPS”). At 50K IOPS, a single flash device consumes 25W and has comparable random access throughput to an aggregate of 250 15K enterprise-class SAS hard disks that consume 10W each. In enterprise environments, the hardware cost and performance characteristics of these “Storage-Class Memories” associated with distributed environments may be problematic. Few applications produce sufficient continuous load as to entirely utilize a single device, and multiple devices must be combined to achieve redundancy. Unfortunately, the performance of these memories defies traditional “array” form factors, because, unlike spinning disks, even a single card is capable of saturating a 10 GB network interface, and may require significant CPU resources to operate at that speed. While promising results have been achieved in aggregating a distributed set of nonvolatile memories into distributed data structures, these systems have focused on specific workloads and interfaces, such as KV stores or shared logs, and assumed a single global domain of trust. Enterprise environments have multiple tenants and require support for legacy storage protocols such as iSCSI and NFS. The problem presented by aspects of storage class memory may be considered similar to that experienced with enterprise servers: Server hardware was often idle, and environments hosted large numbers of inflexible, unchangeable OS and application stacks. Hardware virtualization decoupled the entire software stack from the hardware that it ran on, allowing existing applications to more densely share physical resources, while also enabling entirely new software systems to be deployed alongside incumbent application stacks.

Storage systems are primarily concerned with explicit addresses and address translations: they serve reads and writes to content based on object names and addresses that are included in requests. As the scale and complexity of storage systems continues to mount, an important piece of metadata is often ignored: time. Components of traditional storage systems have failed to make more strategic decisions regarding performance and resource management, in some cases because they do not associate information regarding the time that pieces of data have been accessed in the past. In conventional methodologies for identifying data priority, arbitrary heuristics relating to the recency of data usage as well as proximity in physical storage are used to promote data to higher performance (usually cache) memory. Recency has been shown to be a poor analog for data priority (sometimes referred to as “hotness”), particularly in cases where there are multiple client servers in a scaling organization. While the same can be said of proximity, it is increasingly unhelpful in the context of aggregated and/or distributed memory storage systems, such as for example, virtualized memory resources or any other such systems that present aggregated data resources as a single logical unit. Physical proximity is also unhelpful as technological developments move away from log-based storage techniques; although even in both log- and non-log-based storage techniques, proximity in storage may represent a more or less arbitrary way of identifying related data. In addition, typical heuristics for identifying data that may be related to “hot” data will often involve the association of physically adjacent blocks to recently accessed blocks. On the basis of this association, all such related blocks are often “pre-fetched” into cache (or higher tier data) along with the most recently called data. This may result in a lack of granularity that causes a number of shortcomings: the block with the most recently called data may in fact comprise of other non-related data, and this problem is exacerbated when the associated blocks are pre-fetched and bring along with them additional non-related data that happens to be in the associated block. Another issue is that contiguousness is often arbitrary: blocks in physical proximity increasingly bears no indication of a relationship between subsets of data that exists on the contiguous blocks, particularly in distributed storage systems in which one or more data objects may be stored across a plurality of memory storage devices.

As such, current tiering techniques may in some cases exacerbate the problem of assigning “hot” data to low latency or otherwise high performance memory resources (which is typically more expensive).

Moreover, many systems have historically focused cache management, and indeed most dynamic tiering methodologies stem from work done in this area. Many data management systems have limited historical knowledge of a particular datastream: that is, the size of the cache itself, or of other high-speed memory resources (e.g. RAM). Other systems, lack specific checks to determine if data or storage blocks or chunks are related to one another; rather, assumptions are made which may or may not indicate a relationship in any given situation (e.g. contiguousness). Since data is limited to cache size, such systems are limited in capturing long-lived relationships. Moreover, data management techniques are limited temporally: data which may be considered “hot” soon but which has not been accessed in a long time will almost always reside on slow or high-latency storage resources.

Some cache management methodologies have provided some more nuanced cache management methodologies (e.g. Palmer and Zdonik, “Fido: A Cache That Learns to Fetch”, Proceedings of the 17^{th} International Conference on Very Large Databases, Barcelona, 1991; Li, Chen, Srinivasan and Zhou, “C-Miner: Mining Block Correlations in Storage Systems”, Proceedings of the 3rd USENIX Conference on File and Storage Technology (FAST), 2004; both incorporated by reference herein). In general, however, such methodologies are limited to pre-fetching data which has a higher likelihood of being associated with data that has been requested recently. Pre-fetching constitutes a less holistic analysis of all data for storage on distributed storage, since it primarily considers existing data that is associated with data that has been recently requested or written.

The emergence of commodity PCIe flash marks a remarkable shift in storage hardware, introducing a three-order-of-magnitude performance improvement over traditional mechanical disks in a single release cycle. PCIe flash provides a thousand times more random IOPS than mechanical disks (and 100 times more than SAS/SATA SSDs) at a fraction of the per-IOP cost and power consumption. However, its high per-capacity cost makes it unsuitable as a drop-in replacement for mechanical disks in all cases. Except for niche use cases, most storage consumers will require a hybrid system combining the high performance of flash with the cheap capacity of magnetic disks in order to optimize these balancing concerns. In such systems, the question of how to arrange data across tiers is helpful in optimizing the requirements for wide sets of data. In the time that a single request can be served from disk, thousands of requests can be served from flash. Worse still, IO dependencies on requests served from disk could potentially stall deep request pipelines, significantly impacting overall performance. Traditional approaches to this problem include demand-fault caches and linear extent-based tiering. Demand-fault systems like LRU are relatively simple and make use of limited historical knowledge of workloads; they reactively populate caches after misses on the assumption that workloads will exhibit temporal locality. This assumption may hold up in the short term (although the locality observed at the storage layer is often less prominent than what is seen at the at the application layer due to file system caching). However, it is arguably not the right approach for longer-term management of caches, as it doesn't take into account common diurnal patterns and it can take a relatively long time to respond to phase changes in workloads. Linear extent-based tiering systems take a somewhat more involved approach to data placement, carving address spaces into segments and periodically migrating hot segments to more performant storage. To make this approach tractable, segments are typically quite large (to reduce metadata overhead) and are only relocated at fixed intervals, typically on the order of tens of minutes or hours (to limit migration overhead). Similar to demand-fetch strategies, this approach assumes temporal locality without considering higher-level temporal properties; it also assumes a very coarse-grain spatial locality, which, given the prevalence of small files and fragmentation, may not always hold. A broader understanding of active workloads may be useful in better informing the dynamic placement of data across tiers.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for systems, methods and devices for implementing data management in distributed data storage systems that overcome some of the drawbacks of known techniques, or at least, provide a useful alternative thereto. Some aspects of this disclosure provide examples of such methods, systems and devices.

In accordance with some aspects, systems, methods and devices are provided for monitoring data transactions and placing the associated data in a data storage system. In accordance with some further aspects, systems, methods and devices are also provided for analyzing monitored and stored data for forming associations therebetween.

In one embodiment of the subject matter disclosed herein there are provided methods of monitoring data transactions in a data storage system, the data storage system being in network communication with a plurality of storage resources and comprising at least a data analysis module and a logging module, the method of monitoring comprising steps of: Receiving at the data analysis module at least one data transaction for data in the data storage system, each data transaction having at least one data-related characteristic; Storing in the logging module the at least one data-related characteristic and a data transaction identifier that relates the data transaction to the associated at least one data-related characteristic in the logging module; Analyzing at the data analysis module at least one data-related characteristic related to a first data transaction to determine if the first data transaction shares at least one data-related characteristic with other data transactions stored in the logging module; and in cases where the first data transaction shares at least one data-related characteristic with at least one other data transaction, logically linking the first data transaction with the other data transactions.

In another embodiment of the subject matter disclosed herein, there is provided a data transaction device for monitoring data transactions and placing the associated data in a data storage system, the data storage device comprising a computing processor component and a memory, the memory having instructions located thereon, that when implemented by the computing processor component, that cause the data transaction device to (i) monitor data transactions for data on the data storage system by obtaining at least one data-related characteristic from each data transaction, (ii) store the at least one data-related characteristic for each data transaction, and (iii) analyze each of the stored at least one data-related characteristic to determine if the data transaction associated therewith shares at least one data-related characteristic with another at least one other data transaction and, if so, logically linking the data transactions; the data storage device further comprising a plurality of interfaces for communicatively coupling the data storage device to a plurality of data storage resources and a plurality of data consumers; and a switch that routes each data transaction towards one of the following: at least one of the storage resources, at least one of the data consumers, and a combination thereof.

In another embodiment of the instant disclosure, there is provided a data storage device for use in a distributed storage system, the data storage device comprising: one or more storage resources; a network interface component for communicatively coupling the data storage device to other data storage devices and at least one of a data client and a network switching device; a processor, the processor being configured to implement a set of instructions that cause the device to: migrate data associated with the data storage device to a second data storage device when the current time is related to intervals during a prior time period when the data had a priority above a first predetermined threshold, wherein the second data storage device comprises storage resources having at least one of the following characteristics: lower latency than the storage resources on the data storage device and higher throughput than the storage resources on the data storage device; and accept data associated with a second data storage device when the current time is related to intervals during a prior time period when the data had a priority above a first predetermined threshold, wherein the data storage device comprises storage resources having at least one of the following characteristics: lower latency than the storage resources on the second data storage device and higher throughput than the storage resources on the second data storage device.

In another embodiment of the instant disclosure, there is provided a data storage device for use in a distributed storage system, the data storage device comprising one or more storage resources; a network interface component for communicatively coupling the data storage device to other data storage devices and at least one of a data client and a network switching device; a processor, the processor being configured to implement a set of instructions that cause the device to: migrate data associated with the data storage device to a second data storage device when the current time is related to intervals during a prior time period when the data had a priority below a first predetermined threshold, wherein the second data storage device comprises storage resources having at least one of the following characteristics: higher latency than the storage resources on the data storage device and lower throughput than the storage resources on the data storage device; and accept data associated with a second data storage device when the current time is related to intervals during a prior time period when the data had a priority below a second predetermined threshold, wherein the data storage device comprises storage resources having at least one of the following characteristics: higher latency than the storage resources on the second data storage device and lower throughput than the storage resources on the second data storage device.

In another embodiment of the instant disclosure, there is provided a computer-automated method for prioritizing storage resource allocation in a data storage system having a plurality of networked storage resources, the method comprising: processing a plurality of data transactions for corresponding data in the data storage system, each one of said data transactions having at least one data-related characteristic related thereto; logging each said at least one data-related characteristic in association with a respective data transaction identifier respectively identifying each of said processed data transactions; analyzing said logged data-related characteristics to identify at least one shared data-related characteristic shared within respective subsets of said respectively identified data transactions; logically linking said respectively identified data transactions within each of said respective subsets as a function of each said shared data-related characteristic; and prioritizing allocation of the storage resources for data corresponding to at least one of said respective subsets as a function of said shared data-related characteristic.

In another embodiment of the instant disclosure, there is provided device for prioritizing storage resource allocations in a data storage system having a plurality of networked data storage resources and servicing at least one data consumers, the device comprising: a plurality of ports for communicatively coupling the device to the plurality of data storage resources and the plurality of data consumers; a switch to route data transactions for data on the data storage system between the plurality of storage resources and the plurality of data consumers; a processor; and a memory, said memory having instructions located thereon that when implemented by said processor cause the device to: monitor said data transactions to extract at least one respective data-related characteristic therefrom; log each said data-related characteristic in said memory in association with a respective data transaction identifier; logically link data transaction identifiers into transaction subsets based on shared data-related characteristics; and prioritize allocation of the storage resources for data corresponding to at least one of said transaction subsets as a function of said shared data-related characteristics.

In general, the subject matter of this disclosure relates to the dynamic analysis and placement of data in data storage systems. It includes the assessment of characteristics of the data to, first, assess whether multiple units of data may be related, such units not necessarily being contiguous in storage, and, second, ensuring that all of those data units are moved to storage that best meets the needs of the data consumer for that data. In some cases, this attempts to ensure that “hot” data is stored in low latency, high-performance storage, and “not hot” data is stored in cheaper, higher capacity storage.

Data placement in this disclosure will relate to methodologies of storing or moving data amongst multiple storage media to optimally utilize data storage. It includes, but is not limited to, cache management techniques (described below) and hierarchical tiering.

Cache management techniques generally refer to the promotion of highly used (or, according to currently known heuristics and assumptions, likely to be used soon) data to “cache” storage resources, which are on the one hand typically very fast and highly localized, e.g. RAM, but on the other hand not durable. This is generally so that recently used data, or data that is anticipated to be used relatively soon, will be easily and quickly presented upon request and will minimize the stress on the storage system. In these circumstances, the copy that is on the RAM is usually deleted when it becomes apparent that storage in RAM is no longer necessary and long-term integrity of the data stored on the RAM need not be considered; the primary data will almost always be maintained on more durable storage, but which is not as easily accessed.

In hierarchical tiering, data is moved to the durable storage that best meets the needs of that data. For example, the primary copy may be stored on flash if lower latency in data requests will be likely for that data, and stored on hard disks if lower latency is not required because, for example, the data is only required infrequently or for non-urgent requirements (e.g. periodic disk clean-up at times of low computer usage). In the past, classification of data between that which should be placed in a higher tier of performance or in RAM occurred according to more or less arbitrary heuristics. These arbitrary heuristics may be appropriate in some instances but have a high likelihood in being incorrect entirely or being incorrect at any given time, as will be described below.

The current embodiment of the memory storage system comprises, broadly and logically speaking, three functionalities: a collection functionality, an analysis functionality, and a data placement functionality. These embodiments exist on a system of communicatively interconnected computing devices, network switches and memory storage nodes.

In some embodiments, there are disclosed functionalities for storing any of a number of characteristics that relate to each of the data transactions that pass through the switch; in addition, such data regarding data transactions are stored for arbitrary periods of history. Embodiments relate to the mining of that information to identify relationships between any two or more data, and then making predictions or schedules of when that data may or may not be likely to be called and then moving the associated groups of data to the available memory resources that are most appropriate for that data. Data which is most likely to be called soon by one or more clients, or with high frequency in the near future, even if that data has not been called recently, will be migrated or placed on low-latency and/or high-throughput (as measured in, for example, IOPS, although other performance benchmarking known to a person skilled in the art may be considered). Conversely, in some embodiments, data which is unlikely to be called soon, or will be called with low frequency in an upcoming time period, will be moved to higher latency, lower-performing data. By matching data priority more accurately and dynamically, data storage resources can be managed much more optimally and more appropriate financial investment in the most appropriate memory storage infrastructure is possible.

Rather than relying on a demand-based assessment of data (i.e. by pre-fetching data which may, based on possibly inaccurate or sub-optimal assumptions, be associated with data from a recent data request), embodiments of the instant disclosure can assess all or portions of data stored across the system to determine (a) associations between two or more pieces of data and (b) real-time indications of priority of pieces of data at any given time. Priority of data may be understood as the relative “hotness” or “coldness” of data, as would be understood by a person skilled in the art of computer science or data storage.

Production storage workloads exhibit patterns in time. These patterns may characterize things such as the predictable, diurnal accesses that occur in overnight tasks or when the work day begins. Similarly, they may characterize the specific request properties, such as typical access size or the likeliness of reads versus writes, on individual pieces of data. While the history of interactions with a collection of stored data cannot provide completely accurate predictions of future behavior, it does represent a rich source of metadata that could be used to make workload-aware decisions as systems continue to run. Enterprise storage systems can be improved through the collection and analysis of temporal metadata associated with the data that they store. Just as storage requests are explicitly addressed to objects and offsets within files and disks, they are implicitly addressed in time. As a result, embodiments of the instantly disclosed storage systems might be reasonably extended to collect and persist temporal metadata and then perform, for example, data promotion or tiering to improve overall performance of a storage system. The techniques that have historically been employed in managing decisions for things like data placement and cache population face challenges under the scale and complexity of modern storage implementations. For example, while LRU-based caching (and its variants, ARC, CAR, etc.) tend to perform well when managing a DRAM-based cache that is a very small fraction of the dataset being accessed, they struggle for efficiency as the cache size grows to include more of the tail of an access frequency distribution.

The inclusion of a larger share of high-performance storage within the storage hierarchy is exactly what is happening with the inclusion of SSDs in production storage systems. However, the caching and tiering decisions that are currently used to place data into faster or slower classes of storage incorporate a minimal understanding of workload histories. In addition to this, the flash memories that these large fast storage tiers are composed of have durability and performance characteristics that are highly influenced by data placement and lifetime, but writes are made with little or no understanding of the likelihood that they will be overwritten and invalidated in the immediate future. Embodiments of the instantly disclosed subject matter provide devices, systems and methods for the collection and analysis of temporal metadata and the association of that metadata with stored data in a manner that can be used to make informed decisions in storage systems.

An initial challenge with this class of data has typically been the sheer volume of such data. Subject matter disclosed herein relates to (1) the capture and persisting of live per-request access logs over periods of at least a week in production environments (2) the application of analysis techniques to summarize temporal characteristics on access clusters, collections of stored data that have highly correlated accesses in time; and (3) placing the data accordingly at the most appropriate storage resources at the most optimal time based on the summarized temporal characteristics.

Access clusters, or data clusters, present a summarizing primitive that is reasonable to compute, space efficient to store, and allow the clustering of data without a requirement of address space linearity. In exemplary embodiments, the dynamic placement of active data is shown in a hybrid storage system that includes a relatively large tier of high-performance flash. In this environment, the tail of an LRU includes data with a forward distance that may be 24 hours away or more, and results in very low-value usage of expensive flash. The application of access analysis, as disclosed herein, decouples writes of long-lived data from writes that are likely to be rewritten soon; thereby avoiding fragmentation of live data on disk. The use of access clusters to help explain to storage administrators when investment in additional high-performance storage resources would actually help improve performance is also disclosed. By demonstrating the specific workloads that are in use when high-performance storage is under performance pressure, administrators may make more informed decisions as to when they should invest in scaling out an expensive component of their own systems. The collection, analysis, and exposure of temporal metadata may then be treated as an advisory property in the system. Similar to Grey-box techniques, access clusters represent an additional source of information that may be used in making performance-sensitive operational decisions.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

The invention, both as to its arrangement and method of operation, together with further aspects and advantages thereof, as would be understood by a person skilled in the art of the instant invention, may be best understood and otherwise become apparent by reference to the accompanying schematic and graphical representations in light of the brief but detailed description hereafter:

FIG. 1 is a schematic diagram representative of an architecture of one embodiment of the functionalities in a distributed storage system;

FIG. 2 is a representative diagram of a set of storage nodes in distributed storage system in accordance with one embodiment of the instantly disclosed subject matter;

FIG. 3 is a schematic diagram representative of a distributed data storage system in accordance with one embodiment of the instantly disclosed subject matter;

FIG. 4 are time-series graphs of data transactions of one embodiment of the instantly disclosed subject matter;

FIG. 5 is a representative screen shot of the administrative control of one embodiment of the instantly disclosed subject matter; and

FIG. 6 is a cumulative distribution function of times between accesses to trace blocks in an embodiment of a storage system of the instantly disclosed subject matter.

### DETAILED DESCRIPTION

The present invention will now be described more fully with reference to the accompanying schematic and graphical representations in which representative embodiments of the present invention are shown. The invention may however be embodied and applied and used in different forms and should not be construed as being limited to the exemplary embodiments set forth herein. Rather, these embodiments are provided so that this application will be understood in illustration and brief explanation in order to convey the true scope of the invention to those skilled in the art. Some of the illustrations include detailed explanation of operation of the present invention and as such should be limited thereto.

As used herein, a “computing device” may include virtual or physical computing device, and also refers to any device capable of receiving and/or storing and/or processing and/or providing computer readable instructions or information.

As used herein, “memory” may refer to any resource or medium that is capable of having information stored thereon and/or retrieved therefrom. Memory, as used herein, can refer to any of the components, resources, media, or combination thereof, that retain data, including what may be historically referred to as primary (or internal or main memory due to its direct link to a computer processor component), secondary (external or auxiliary as it is not always directly accessible by the computer processor component) and tertiary storage, either alone or in combination, although not limited to these characterizations. Although the term “storage” and “memory” may sometimes carry different meaning, they may in some cases be used interchangeably herein.

As used herein, a “storage resource” may comprise a single medium or unit, or it may be different types of resources that are combined logically or physically. The may include memory resources that provide rapid and/or temporary data storage, such as RAM (Random Access Memory), SRAM (Static Random Access Memory), DRAM (Dynamic Random Access Memory), SDRAM (Synchronous Dynamic Random Access Memory), CAM (Content-Addressable Memory), or other rapid-access memory, or more longer-term data storage that may or may not provide for rapid access, use and/or storage, such as a disk drive, flash drive, optical drive, SSD, other flash-based memory, PCM (Phase change memory), or equivalent. A storage resource may include, in whole or in part, volatile memory devices, non-volatile memory devices, or both volatile and non-volatile memory devices acting in concert. Other forms of memory storage, irrespective of whether such memory technology was available at the time of filing, may be used without departing from the spirit or scope of the instant disclosure. For example, any high-throughput and low-latency storage medium can be used in the same manner as PCIe Flash, including any solid-state memory technologies that will appear on the PCIe bus. Technologies including phase-change memory (PCM), spin-torque transfer (STT) and others will more fully develop. Some storage resources can be characterized as being high- or low-latency and/or high- or low-throughput and/or high- or low-capacity; in many embodiments, these characterizations are based on a relative comparison to other available storage resources on the same data server or within the same distributed storage system. For example, in a data server that comprises one or more PCIe Flash as well as one or more spinning disks, the PCIe flash will, relative to other storage resources, be considered as being lower latency and higher throughput, and the spinning disks will be considered as being higher latency and higher throughput. Higher or lower capacity depends on the specific capacity of each of the available storage resources, although in embodiments described herein, the form factor of a PCIe flash module is of lower capacity than a similarly sized form factor of a spinning disk. It may include a memory component, or an element or portion thereof, that is used or available to be used for information storage and retrieval.

A “computing processor component” refers in general to any component of a physical computing device that performs arithmetical, logical or input/output operations of the device or devices, and generally is the portion that carries out instructions for a computing device. The computing processor component may process information for a computing device on which the computing processor component resides or for other computing devices (both physical and virtual). It may also refer to one or a plurality of components that provide processing functionality of a computing processor component, and in the case of a virtual computing device, the computing processor component functionality may be distributed across multiple physical devices that are communicatively coupled. Computing processor component may alternatively be referred to herein as a CPU or a processor.

As used herein, “priority” of data generally refers to the relative “hotness” or “coldness” of data, as these terms would be understood by a person skilled in the art of the instant disclosure. The priority of data may refer herein to the degree to which data will be, or is likely to be, requested, written, or updated at the current or in an upcoming time interval. Priority may also refer to the speed which data will be required to be either returned after a read request, or written/updated after a write/update request. In some cases, a high frequency of data transactions (i.e. read, write, or update) involving the data in a given time period, the higher the priority. Alternatively, it may be used to describe any of the above states or combinations thereof. In some uses herein, as would be understood by a person skilled in the art, priority may be described as temperature or hotness. As is often used by a person skilled in the art, hot data is data of high priority and cold data is data of low priority. The use of the term “hot” may be used to describe data that is frequently used, likely to be frequently used, likely to be used soon, or must be returned, written, or updated, as applicable, with high speed; that is, the data has high priority. The term “cold” could be used to describe data that is that is infrequently used, unlikely to be frequently used, unlikely to be used soon, or need not be returned, written, updated, as applicable, with high speed; that is, the data has low priority. Priority may refer to the scheduled, likely, or predicted forward distance, as measured in time, between the current time and when the data will be called, updated, returned, written or used.

As used herein, the term “client” may refer to any piece of computer hardware or software that accesses a service or process made available by a server. It may refer to a computing device or computer program that, as part of its operation, relies on sending a request to another computing device or computer program (which may or may not be located on another computer or network). In some cases, web browsers are clients that connect to web servers and retrieve web pages for display; email clients retrieve email from mail servers. The term “client” may also be applied to computers or devices that run the client software or users that use the client software. Clients and servers may be computer programs run on the same machine and connect via inter-process communication techniques; alternatively, they may exist on separate computing devices that are communicatively coupled across a network. Clients may communicate with servers across physical networks which comprise the internet. In accordance with the OSI model of computer networking, clients may be connected via a physical network of electrical, mechanical, and procedural interfaces that make up the transmission. Clients may utilize data link protocols to pass frames, or other data link protocol units, between fixed hardware addresses (e.g. MAC address) and will utilize various protocols, including but not limited to Ethernet, Frame Relay, Point-to-Point Protocol. Clients may also communicate in accordance with packetized abstractions, such as the Internet Protocol (IPv4 or IPv6) or other network layer protocols, including but not limited to Internetwork Packet Exchange (IPX), Routing Information Protocol (RIP), and Datagram Delivery Protocol (DDP). Next, end-to-end transport layer communication protocols may be utilized by certain clients without departing from the scope of the instant disclosure (such protocols may include but not limited to the following: AppleTalk Transaction Protocol (“ATP”), Cyclic UDP (“CUDP”), Datagram Congestion Control Protocol (“DCCP”), Fibre Channel Protocol (“FCP”), IL Protocol (“IL”), Multipath TCP (“MTCP”), NetBIOS Frames protocol (“NBF”), NetBIOS over TCP/IP (“NBT”), Reliable Datagram Protocol (“RDP”), Reliable User Datagram Protocol (“RUDP”), Stream Control Transmission Protocol (“SCTP”), Sequenced Packet Exchange (“SPX”), Structured Stream Transport (“SST”), Transmission Control Protocol (“TCP”), User Datagram Protocol (“UDP”), UDP Lite, Micro Transport Protocol (“μTP”). Such transport layer communication protocols may be used to transport session, presentation- or application-level data. Some application-level data, including RPC and NFS, among many others which would be known to a person skilled in the art. Network communication may also be described in terms of the TCP/IP model of network infrastructure; that is, the link layer, internet layer, transport layer, and application layer. In general, applications or computing devices that request data from a server or data host may be referred to as a client. In some cases, a client and the entity that is utilizing the client may jointly be referred to as a client; in some cases, the entity utilizing the client is a human and in some cases it may be another computing device or a software routine.

As used herein, the term “server” refers to a system or computing device (e.g. software and computer hardware) that responds to requests from one or more clients across a computer network to provide, or help to provide, a network service. The requests may be abstracted in accordance with the OSI layer model or the TCP/IP model. Servers may provide services across a network, either to private users inside a large organization or to public users via the Internet.

As used herein, “latency” of memory resources may be used to refer to a measure of the amount of time passing between the time that a storage resource or server receives a request and the time at which the same storage resource or server responds to the request (or the time such response is received).

As used herein, “throughput” of memory resources refers to the number of input/output operations per second that a storage resource or server can perform. Typically, this measurement used is “IOPS” but other measurements are possible, as would be known to a person skilled in the art.

As used herein, a “data transaction” may refer to any instructions or requests relating to the reading, writing, updating, and/or calling of data; and such data transactions may comprise of (i) data requests, generally issued by data clients or by entities requesting an action be taken with specific data (e.g. read, write, update), as well as (ii) data responses, generally returned by data servers in response to a data request. In embodiments, data requests originate at data clients; in embodiments, they may originate from applications running on or at a data client. In embodiments, data requests are sent to data servers and then responded to appropriately, and a response is returned to the data client. In embodiments, data requests may be asymmetrical in that a write request generally carries a relatively large amount of data from data client to the distributed data storage system, since it must include the data to be written, and the data storage system returns a relatively much smaller response that acknowledges receipt and confirms that the data was written to memory; in embodiments, a read request is relatively small amount of data, whereas the response to the read request from the data storage system is the data that was read and is therefore much larger than the request, relatively speaking Data requests are often made in accordance with an application or session layer abstraction; in embodiments, they are instructions from one computing device (or other endpoint) to implement an action or a subroutine at another computing device. In embodiments, data requests are sent over the network as NFS requests (application layer) contained within TCP segments (endpoint-to-endpoint data stream) which in turn are carried in IP packets over the internet, across Ethernet-based devices within frames across networking devices. Other exemplary data requests may form RPC (Remote Procedure Call) requests, which may in turn comprise NFS requests or other types of data requests. Other examples include iSCSI, SMB, Fibre Channel, FAT, NTFS, RFS, as well as any other file system requests and responses which would be known to persons skilled in the art of the instant disclosure. In embodiments utilizing NFS, an NFS request and its corresponding response, would each be considered a data transaction.

Typical computing servers are database server, file server, mail server, print server, web server, gaming server, application server, or some other kind of server. Nodes in embodiments of the instant disclosure may be referred to as servers. Servers may comprise one or more storage resources thereon, and may include one or more different types of data storage resource. In embodiments of the distributed storage systems disclosed herein, storage resources are provided by one or more servers which operate as data servers. The one or more data servers may be presented to clients as a single logical unit, and in some embodiments will share the same IP address; data communication with such one or more groups can share a single distributed data stack (such as TCP, but other transport layer data streams or communication means are possible, and indeed data stacks in different OSI or TCP/IP layers can be used). In some cases, the servers will jointly manage the distributed data stack; in other cases, the distributed data stack will be handled by the switch; and in yet other cases a combination of the switch and the one or more servers will cooperate to handle the distributed data stack.

In embodiments, client applications communicate with data servers to access data resources in accordance with any of a number of application-level storage protocols, including but not limited to Network File System (“NFS”), Internet Small Computer System Interface (“iSCSI”), and Fiber Channel. Other storage protocols known to persons skilled in the art pertaining hereto may be used without departing from the scope of the instant disclosure. Additionally, object storage interfaces such as Amazon's S3, analytics-specific file systems such as Hadoop's HDFS, and NoSQL stores like Mongo, Cassandra, and Riak are also supported by embodiments herein. Second, 10 GB interfaces became commonplace on servers on servers, and Ethernet switches inherited “software defined” capabilities including support for OpenFlow.

In one embodiment of the subject matter disclosed herein there are provided methods of monitoring data transactions in a data storage system, the data storage system being in network communication with a plurality of storage resources and comprising at least a data analysis module and a logging module, the method of analyzing comprising the following steps: Receiving at the data analysis module at least one data transaction for data in the data storage system, each data transaction having at least one data-related characteristic; Storing in the logging module the at least one data-related characteristic and a data transaction identifier that relates the data transaction to the associated at least one data-related characteristic in the logging module; Analyzing at the data analysis module at least one data-related characteristic related to a first data transaction to determine if the first data transaction shares at least one data-related characteristic with other data transactions stored in the logging module; and in cases where the first data transaction shares at least one data-related characteristic with at least one other data transaction, logically linking the first data transaction with the other data transactions.

In some embodiments the subject matter disclosed herein there are provided computer implemented methods of monitoring data transactions in a data storage system, the data storage system being in network communication with a plurality of storage resources and comprising at least a data analysis module and a logging module, the method of analyzing comprising the following steps: Receiving at the data analysis module at least one data transaction for data in the data storage system, each data transaction having at least one data-related characteristic; Storing in the logging module the at least one data-related characteristic and a data transaction identifier that relates the data transaction to the associated at least one data-related characteristic in the logging module; Analyzing at the data analysis module at least one data-related characteristic related to a first data transaction to determine if the first data transaction shares at least one data-related characteristic with other data transactions stored in the logging module; and in cases where the first data transaction shares at least one data-related characteristic with at least one other data transaction, logically linking the first data transaction with the other data transactions. Such computer-implemented methods may, in some embodiments, be implemented by computer processors on or in communication with computing devices, such devices also having access to sets of instructions stored on a communicatively coupled storage module, the sets of instructions configured to carry out the steps noted above in this paragraph, or indeed any steps of any method or functionality described herein.

In some embodiments, the data storage system comprises one or more network switching devices which communicatively couple data clients with data servers. Network switching devices may be used to communicatively couple clients and servers. Some network switching devices may assist in presenting the one or more data servers as a single logical unit; as, for example, an NFS server. In other cases, the network switching device also views the one or more data servers as a single unit with the same IP address and passes on the data stack, and the data servers operate to cooperatively distribute the data stack amongst themselves.

Exemplary embodiments of network switches include, but are not limited to, a commodity 10 Gb Ethernet switching fabric as the interconnect between the data clients and the data servers; in some exemplary switches, there is provided at the switch a 52-port 10 Gb Openflow-Enabled Software Defined Networking (“SDN”) switch (and supports 2 switches in an active/active redundant configuration) to which all data servers and clients are directly attached. SDN features on the switch allow significant aspects of storage system logic to be pushed directly into the network and an approach to achieving scale and performance. In some embodiments, the switch may facilitate the use of a distributed transport-layer communication (or indeed session-layer communication) between a given client and a plurality of data servers (or hosts or nodes).

In embodiments, the one or more switches may support network communication between one or more clients and one or more data servers. In some embodiments, there is no intermediary network switching device, but rather the one or more data servers operate jointly to handle a distributed data stack. An ability for a plurality of data servers to manage, with or without contribution from the network switching device, a distributed data stack contributes to the scalability of the distributed storage system; this is in part because as additional data servers are added they continue to be presented as a single logical unit (e.g. as a single NFS server) to a client and a seamless data stack for the client is maintained and which appears, from the point of view of the client, as a single endpoint-to-endpoint data stack.

In embodiments, the storage resources are any computer-readable and computer-writable storage media that are communicatively coupled to the data clients over a network. In embodiments, a data server may comprise a single storage resource; alternative embodiments, a data server may comprise a plurality of the same kind of storage resource; in yet other embodiments, a data server may comprise a plurality of different kinds of storage resources. In addition, different data servers within the same distributed data storage system may have different numbers and types of storage resources thereon. Any combination of number of storage resources as well as number of types of storage resources may be used in a plurality of data servers within a given distributed data storage system without departing from the scope of the instant disclosure.

In embodiments, a particular data server comprises a network data node. In embodiments, a data server may comprise multiple enterprise-grade PCIe-integrated components, multiple disk drives, a CPU and a network interface controller (NIC). In embodiments, a data server may be described as balanced combinations of PCIe flash, multiple 3 TB spinning disk drives, a CPU and 10 GB network interfaces that form a building block for a scalable, high-performance data path. In embodiments, the CPU also runs a storage hypervisor which allows storage resources to be safely shared by multiple tenants, over multiple protocols. In some embodiments, the storage hypervisor, in addition to generating virtual memory resources from the data server on which the hypervisor is running, the hypervisor is also in data communication with the operating systems on other data servers in the distributed data storage system, and thus can present virtual storage resources that utilize physical storage resources across all of the available data resources in the system. The hypervisor or other software on the data server may be utilized to distribute a shared data stack. In embodiments, the shared data stack comprises a TCP connection with a data client, wherein the data stack is passed or migrates from data server to data server. In embodiments, the data servers can run software or a set of other instructions that permits them to pass the shared data stack amongst each other; in embodiments, the network switching device also manages the shared data stack by monitoring the state, header, or content information relating to the various protocol data units (PDU) passing thereon and then modifies such information, or else passes the PDU to the data server that is most appropriate to participate in the shared data stack.

In embodiments, the shared data stack is a TCP end-to-end communication that is carried over the network within IP packets, which in turn form Ethernet frames. The stream abstraction of TCP communication is, in embodiments, participated in by those data servers that: (i) hold the information, or (ii) are available or are most appropriate based on the current operational characteristics of those data servers as they relate to the data (such as in the case where there are multiple copies of data across a plurality of data servers for redundancy or safety). The shared participation may be implemented by passing all the necessary information from one data server to another so that the second data server can respond to a data request within the TCP stream, as if the TCP response came from the same data server. Alternatively, the software and/or data server protocols may respond directly to the network switching device, which manages the TCP separate data stacks from the respective data servers and combines them into a single TCP stack. In other embodiments, both the group of data servers and the network switching device participate in this regard; for example, the data servers share a single TCP data stack and the network switching device performs some managing tasks on the data stack to ensure its integrity and correct sequencing information. In embodiments, the data requests are sent as NFS requests in TCP segments forming a stream of data (in this case, the TCP data stream is the data stack). The TCP segments are packaged into IP packets in accordance with current communication protocols.

In embodiments, storage resources within memory can be implemented with any of a number of connectivity devices known to persons skilled in the art; even if such devices did not exist at the time of filing, without departing from the scope and spirit of the instant disclosure. In embodiments, flash storage devices may be utilized with SAS and SATA buses (˜600 MB/s), PCIe bus (˜32 GB/s), which supports performance-critical hardware like network interfaces and GPUs, or other types of communication system that transfers data between components inside a computer, or between computers. In some embodiments, PCIe flash devices provide significant price, cost, and performance tradeoffs as compared to spinning disks. The table below shows typical data storage resources used in some exemplary data servers.

| | Capacity | | Throughput | | Latency | Power | Cost |
|---|---|---|---|---|---|---|---|
| 15K RPM | 3 | TB | 200 | IOPS | 10 ms | 10 W | $200 |
| Disk | | | | | | | |
| PCIe Flash | 800 | GB | 50,000 | IOPS | 10 μs | 25 W | $3000 |

In embodiments, PCIe flash is about one thousand times lower latency than spinning disks and about 250 times faster on a throughput basis. This performance density means that data stored in flash can serve workloads less expensively (16× cheaper by IOPS) and with less power (100× fewer Watts by IOPS). As a result, environments that have any performance sensitivity at all should be incorporating PCIe flash into their storage hierarchies. In embodiments, specific clusters of data are migrated to PCIe flash resources at times when these data clusters have high priority; in embodiments, data clusters having lower priority at specific times are migrated to the spinning disks. In embodiments, cost-effectiveness of distributed data systems can be maximized by either of these activities, or a combination thereof.

In some embodiments, the speed of PCIe flash may have operational limitations; for example, at full rate, a single modern PCIe flash card is capable of saturating a 10 GB/s network interface. As a result, prior techniques of using RAID and on-array file system layers to combine multiple storage devices does not provide additional operational benefits in light of the opposing effects of performance and cost. In other words, there is no additional value on offer, other than capacity, which can be provided by lower-cost and lower performing storage resources, to adding additional expensive flash hardware behind a single network interface controller on a single data server. Moreover, unlike disks, the performance of flash in embodiments may be demanding on CPU. Using the numbers in the table above, the CPU driving the single PCIe flash device has to handle the same request rate of a RAID system using 250 spinning disks.

In general, PCIe flash is about sixty times more expensive by capacity. In storage systems comprising a plurality of storage resource types, capacity requirements gravitate towards increase use of spinning disks; latency and throughput requirements gravitate towards flash. In embodiments, there is provided a dynamic assessment of priority of data across the data stored in the system and using that information to place data into the most appropriate storage resource type. Such dynamic assessment permits the allocation of data which shares a data-related characteristic to be associated with data storage resources having the optimal, or, given the nature of such data-related characteristics, the most closely matched performance characteristics; such performance characteristics may refer to latency, throughput, power-consumption, capacity, any other characteristics that relate to operational capabilities and/or the quality thereof as may be understood by a person skilled in the art, or any combination thereof.

In some embodiments, there is provided a data analysis module for hooking into or reading from a data stream and collecting information from the data stream, including metadata relating to data requests and responses thereto being communicated over the data stream, as well as metadata relating to the data associated with the data request or response (that is, the data which is being read, written or updated, for example). In some embodiments, the data analysis module may hook or read information that identifies a data request or its associated data, or the metadata associated therewith. In embodiments, the data analysis module may utilize the identifying information to obtain metadata or other data, such as aggregated statistical data, from other sources; for example, the identifying information may allow the data analysis module to obtain metadata regarding the data request (or the data associated therewith) from other sources such as a database or tables therein, or usage information of that data relating to a client. In embodiments, the data analysis module causes the data that was hooked or read from the data stream to be written into the logging module. The data analysis module comprises a computer processing component. In embodiments, the computer processing component may reside on some or all of the data servers in the distributed storage system, the network switching component, or another computing device communicatively coupled to the distributed storage system having access to the data stream. In embodiments, there are a plurality of data analysis modules reading from and collecting metadata from each data server, wherein the metadata is aggregated and analyzed for linkage as an aggregate, or where the analyses are conducted at each data server and analyses regarding data clusters (i.e. groups of data that are logically linked) at each such server are collated or aggregated at a single computing processing component. In some embodiments, the data analysis module may be considered to be a data analysis daemon, wherein a daemon may be understood by a person skilled in the art to be a computer program that runs as a background process, rather than being under the direct control of an interactive user of a data client.

In some embodiments, there is provided a logging module. In general, the logging module comprises of data storage resources communicatively coupled to some or all of the data servers, either as dedicated one or more storage resources for this purpose, or as storage resources intended for live data or client data that is made available for the logging module across the distributed data storage system by a plurality of the data servers. The logging module is configured in some embodiments to store or log collected data regarding any one or more data streams coming into the distributed data storage system; in some embodiments, such collection may be maintained indefinitely and/or for arbitrary periods of time. In such embodiments, collection of data is not limited to available cache memory resources, for example. In embodiments, metadata is logged for all data transactions during a particular time period; in other embodiments, metadata from a sampling of data transactions is logged. The amount of time during which metadata is collected, as well as the time that metadata is maintained, is indefinite, adjustable, and not limited to the amount of storage resources available to any one computing device in the distributed data storage system. In some embodiments, each networking switching device and/or data server may have a separate logging module, which may or may not be aggregated; in some embodiments, there is a centrally administered logging module. The storage resources available to the logging module may comprise dedicated physical or virtual storage resources, but in some embodiments, the use of dark storage is utilized for logging data transaction metadata. As used herein, dark storage refers to physical locations throughout the distributed data storage system which have reduced rates of use, or rare or infrequent use and can therefore be used by the logging module to store the collected information without impacting the available resources for data or storage used by clients. Since the status of such physical locations with respect to their actual or predicted usage for live or client-related data may be dynamic, the storage resources and locations thereon for usage as dark storage may be frequently changed. In embodiments, dark storage may refer to available storage capacity on connected storage resources that is not currently in use, or expected to be in use in the near future, for live or client related data.

In embodiments, the logging module uses persistent storage resources. In this context, persistent memory is maintained after use and the data stored thereon may not be written over, dropped, disregarded or deleted until such data in its current state is no longer relevant or needed. This is in contradistinction to, for example, cache memory, which often promotes copies of live data for when such data has a high-priority but since the data is stored in persistent memory elsewhere, the copy on the cache need not be maintained after the priority of the data has decreased and is allowed to be overwritten or deleted whenever there is sufficient amounts of high priority data that exceeds the size of the cache.

In some embodiments, the logging module logs or stores metadata relating to one of data transactions or data associated with a data transaction. The metadata may include any data-related characteristic of the data transaction, including but not limited to the time the transaction was made; whether the transaction was a request or a response; whether the associated request was a read, write, update, or other; an identifier of the requesting client; an identifier of the user of the client; identifier of other data requests made shortly before or shortly after the data request; the size of the data transaction; the application-type of the data transaction (e.g. NFS, NTFS, etc.); the transport protocol of the data stack on which the data transaction arrived (e.g. TCP, UCP, etc.); any header information from any incoming protocol data unit; the field, table, schema, or database to which the data transaction relates; and any other information or value which may describe a property or characteristic of the data transaction. The metadata may also include any data-related characteristic of the data associated with the transaction, including but not limited to the size of the data, the location(s) of the data, priority information relating to the data (e.g. predicted forward distance), the time of request, the time of request within a specified or determined epoch (e.g. hour, day, week, work-week, weekend, month), metadata from any record, field, table, schema, database or portion thereof of which the data may be a part; recency and frequency of use; identity of current and past requesting clients; and any other information that may describe a property or characteristic of the data. The analysis module may use any or all of this information, alone or in combination to make an assessment of whether a piece of data is part of a cluster (i.e. it is associated with other pieces of data) or an assessment of priority for any given piece of data; the information used for the former need not be the same as the information for the latter.

The data analysis module may in some embodiments assess a number of characteristics of data. In some embodiments the analysis includes an assessment of data transactions as they are received or transmitted by the network switching device or the one or more data servers; the analysis also possibly including an analysis of the data associated with such transactions and/or the metadata associated with such data transactions and/or their respective associated data. In some embodiments, the analysis includes data transactions and/or the data associated with such requests and/or related metadata which has previously been received or transmitted by the distributed data storage system and in respect of which metadata was previously stored in the logging module. The data analysis module may in some embodiments analyze characteristics of the data transactions and/or the data associated with them at each discrete data server and then make predictions regarding similar data on other data servers. In embodiments, the data analysis module analyzes one or more of the: data transactions, the data associated with data transactions, or the related metadata; in many embodiments, the purpose of the analysis has two aspects: (1) to identify groups or clusters of related information, wherein such relationship indicates that access to or writes of one piece of data in the cluster may increase the likelihood that another piece of data in the group or cluster will also be accessed or updated; and (2) a determination, prediction, or schedule of the priority of data or given cluster or group of data across a future time period. In embodiments, these analyses can be conceptualized as follows: (1) identify groups or clusters of pieces of data that have been associated with a data transaction, wherein the pieces of data form a part of the group of cluster due the sharing of one or more data related characteristic; and (2) determining the forward distance of at least one piece of data from at least one cluster as previously determined by the data analysis module. The forward distance of a piece of data may in some embodiments indicate the priority of same, or in some embodiments be a proxy for priority; forward distance for a given piece of data is the quantity of time between the current point in time and the point in time when that piece of data is will be access, read, written, updated, or in any case, involved in a data transaction.

In some embodiments, there are provided methods of analyzing data transactions to a storage system, wherein the method comprises, inter alia, the steps of, for at least one received data request, analyzing the priority of data associated with the at least one data transaction at intervals during a first time period. In embodiments, this is assessed by analyzing the frequency of data transactions relating to the same data over a given time period, such as for example a work day, a twenty four hour period, a weekend, or any other time period as may be required by an administrator of the system. In embodiments, the first time period may be any time period of interest; in some cases, the first time period may have relevance to a future time period, and usage patterns of data within that first time period may be predictive of usage patterns of the same data in related or similar time periods in the future. For example, log-in information in a database that are shown to be heavily queried during the first hour of a work day, and then again during a short time interval after a lunch hour, is clearly of high priority at those specific times; moreover, there is a very high likelihood that they will be of high priority at the same times of the following day (unless of course that day is Saturday, Sunday or a non-working or statutory holiday). As such, in some embodiments, immediately before future time intervals that are related to past time intervals showing high priority for a cluster or group of data, irrespective of reduced recency and irrespective of the high usage of other non-related data, the analysis module is configured to indicate high priority for the same cluster in the second related time interval. In some embodiments, the analysis module will develop predictions of priority for data (and by extension, in some embodiments, the other data in a data cluster) in upcoming time periods based on an association with prior time periods. In other embodiments, the analysis module will develop a priority schedule for clusters of data across a time interval, wherein the priority across the time period for the schedule is assessed; alternatively, those times where the priority for data that is above or below respective high and low priority thresholds is associated with intervals within the time period to which the schedule applies. Aspects of the distributed storage system cause the data that is scheduled to be above the high priority threshold to be moved to low-latency and/or fast-throughput storage resources (e.g. PCIe Flash) and data that is scheduled to be below the low priority threshold to be moved to higher latency and slower throughput storage resources (e.g. spinning disk). In some cases, the predetermined thresholds can be set by a system administrator; in other cases, the predetermined thresholds may be determined by measuring various metrics relating to the optimal usage and capacity of high performance and lower performance memory. In other cases, the thresholds may be adjusted iteratively by the administrator or by a processor in the distributed storage system in order to find optimal thresholds which maximize the cost-effectiveness or other metrics of the system: an adjustment is made to one or more thresholds, determining if there is an increase or a decrease in the use of storage resources with the appropriate priority of data, and depending on whether there is an increase of decrease respectively continue to adjust or undo the prior adjustment in the respective thresholds.

In some embodiments, there are provided methods of analyzing data transactions to a storage system, wherein the method comprises, inter alia, at intervals during a second time period that are associated with the intervals from the first time period, placing on least one lower latency or higher throughput data storage resource: (i) data that had a priority at the intervals in the first time period that was greater than a first threshold value and (ii) data whose associated data transactions are logically linked with the data transactions of data in (i). Conversely, in some embodiments, there are provided methods of analyzing data transactions to a storage system, wherein the method comprises, inter alia, at intervals during a second time period that are associated with the intervals from the first time period, placing on least one higher latency or lower performing data storage resource: (i) data that had a priority at the intervals in the first time period that was less than a second threshold value and (ii) data associated with data transactions that are logically linked with the data requests in (i). In some cases, two or more pieces of data that are logically linked with one another will be referred to as a data cluster; in some cases, a data cluster can comprise of a single piece of data or the just the data associated with a single data transaction, if there are no other pieces of data that share, or are known to share, a data-related characteristic.

In exemplary embodiments, the analysis module will determine whether there is any data stored across the distributed data storage system that has a priority that is above a first priority threshold at any previous time intervals that is related to a current or imminent time interval. If there is any such data, a processor on one of the data servers, the network switch, or some other communicatively coupled computing device, will then assess whether the storage resource associated with such data is of sufficiently low latency or throughput (relative to other available storage resources). If the latency or throughput of the current storage resource is insufficient given the priority of the data and the latency or throughput of other available storage resources, the processor will migrate the data to such other available storage resources. This may be understood as promoting high priority data to higher performing storage resources.

In some embodiments, the analysis module will determine whether there is any data stored across the distributed data storage system that has a priority that is below a second priority threshold at any previous time intervals that is related to a current or imminent time interval. If there is any such data, a processor on one of the data servers, the network switch, or some other communicatively coupled computing device, will then assess whether the storage resource associated with such data is characterized by low latency or fast throughput (relative to other available storage resources). If the latency or throughput of the current storage resource is unnecessary given the priority of the data and the latency or throughput of other available storage resources, the processor will migrate the data to such other available storage resources having higher latency and slower throughput. This may be understood as demoting low priority data to lower performing storage resources.

In some embodiments, the analysis module and/or processor will do either or both promotion of high priority data and demotion of low priority data. In embodiments, the migration and/or acceptance of data between storage resources is handled by a set of software instructions located on (or accessible to) each data server. In embodiments, the set of software instructions is implemented by a processor on each data server. In other embodiments, the migration of data between data servers is handled by a centralized administration service, which may be located on one or more of the data servers, a network switching device, or any other computing device coupled to each of the available data servers.

In some embodiments, one or more of the data servers can be configured to cause data on stored thereon to migrate from one accessible storage resource to another. In some embodiments, one or more of the data servers can be configured to accept data to an accessible storage resource. In some embodiments, one or more of the data servers can both migrate data and accept data. In some cases, a data server will migrate data to another data storage device when a current time period is related to a prior time period when that data had a priority above a first predetermined threshold, and the other data storage device has available storage resources that are of lower latency and/or faster throughput. The data servers in some embodiments may be configured to accept data from other data servers depending generally on whether the other data servers are storing data having priority above a predetermined priority threshold and the data server has storage resources with lower latency and/or faster throughput than the other data server. In some embodiments, the one or more data servers are configured to migrate and/or accept data to/from another data server that is below the same or different predetermined priority threshold, generally when the data server has storage resources that are of higher latency and/or slower throughout. In some embodiments, the data servers are configured to migrate and accept data for both cases (i.e. above and below the same or respective priority thresholds).

Embodiments of the instant disclosure, recognize in real-time or anticipate the storage requirements based on the priority of the data (e.g. how “hot”, sensitive, etc.). Some embodiments dynamically recognize what would be the best type of available memory based on the storage requirements of data based on its priority.

Embodiment of the memory storage system comprise, broadly and logically speaking, three functionalities: a collection functionality, an analysis functionality, and a data placement functionality. These embodiments exist on a system of communicatively interconnected client computing devices, a network switching device and memory storage nodes.

The memory storage nodes comprise, individually or as a combination, a plurality of types of storage resources. Each type of storage resource may have differing characteristics from the other types, making each type of storage resource more or less conducive to achieving particular operational objectives. In one embodiment, each storage node comprises a CPU, a low latency memory resource, such as flash or SSD, a higher latency memory resource, such as a hard disk drive, and a network interfacing controller.

The one or more clients may comprise computing devices which submit data requests, such as read, write or update requests.

The network switching device, in some embodiments, routes those requests to the appropriate storage node. In some embodiments, the switch may comprise centralized intelligence operating from, for example, a CPU in the switch; the switch may assign memory resources in the nodes to specific data and then manage those assignments in real time to ensure optimal assignment of data to achieve operational objectives. In some embodiments, this assignment and management function may be pushed down to specific nodes or groups of nodes.

### Collection Functionality

The collection functionality in some embodiments is run by a service located on an interconnected CPU on each node, or in some cases at the network switching device. It is configured to monitor and log a data request stream as such data requests are received on the live memory storage system. The data request stream comprises data requests for the writing, updating or reading of data in or intended for storage. The CPU comprises an instruction module or function that hooks into a data stack comprising of one or more data streams to collect data that describes characteristics about individual data requests. A data stream may be considered to be the stream of data passing between a client and the distributed storage system (e.g., a stream of data requests and responses thereto in the other direction comprising a stream of NFS requests over a TCP communication); the data stack is all the data from the one or more data streams passing through the network switching device and/or the data servers. Information may be pulled from the data request itself, or it may be configured to obtain the data from elsewhere (e.g. metadata of the data to which the request pertains from a database from which it was accessed or to which it is associated in the distributed storage system, which may not be visible to the login module or the nodes in some NFS systems). Although some embodiments may be limited to the collection of data that can be pulled from the data request, other embodiments may be configured access external or additional information, such as metadata associated with the data request which is not available in some NFS requests, for example but which may be available through external sources like supplemental data requests to the client or the storage resource.

The collection functionality may in some embodiments buffer a number of request traces. A request trace is associated with an individual data request and it comprises data that describes characteristics of that data request, or links thereto. Once a large enough buffer has been created, a batch is sent to a tracing function (which in some embodiments is called “TracerD”) and the traces are aggregated. This tracing function, and resulting aggregate data set, may in some embodiments exist for each node in the memory system, or there may be an aggregation of the aggregates at a centralized service.

Although not the case in all embodiments, aggregated data streams may, in some embodiments, be stored within the memory system. In some embodiments, there will be dedicated or designated memory resources for such aggregates. In other embodiments, the aggregates will be stored in dark storage in the memory storage system. Dark storage may be considered as low priority and low usage storage areas; when it is needed for storing live data, the data that is stored there is discarded or moved to other areas of dark storage, if available.

Workload traces have long been an important source of information for systems researchers. However, the acquisition of storage traces has traditionally required significant effort on behalf of both researchers and storage administrators in overcoming the political and technological challenges of large-scale data collection in live deployments. Indeed, despite their acknowledged value, only a handful of production traces are available at sources like the SNIA IOTTA Repository, and even fewer of these capture more than one week's worth of activity. This represents a lost opportunity. In addition to being valuable to researchers in general, workload metadata can be instrumental in configuring and tuning individual storage systems. In embodiments, there is data and metadata relating to a data request which can be traced and stored. The following shows an example of such data and metadata:

| Request | Trace Record Format | | |
|---|---|---|---|
| Property | Full | Abbreviated | Compacted |
| File ID | 1 | 1 | 1 |
| Type | 1 | 1 | 1 |
| Time | 8 | 4 | 1, 4 |
| Address | 8 | 8 | 0, 2, 8 |
| Size | 4 | 4 | 1, 4 |
| Latency | 4 | NA | NA |
| Record | 26 | 18 | 4-18 |
| Size | | | |
| Record | 10.5 | 3.1 | 2.6 |
| Size | | | |
| (bzip2) | | | |
| MSR | 4.1 G | 1.3 G | 1 G |
| Trace | | | |
| (bzip2) | | | |

Continual analysis of workload characteristics, which may be characterized in some embodiments using the data and metadata shown above (or indeed, additional metadata not shown in the table above regarding the data request or the data associated with the data request) would enable storage controllers to make a number of online optimizations tailored specifically for the workloads they serve. Storage systems disclosed herein may collect detailed workload histories by default and then retain them for as long as is useful. In embodiments herein, by combining domain-specific knowledge of trace data with standard compression techniques, the details of a single data request can be represented in just over two and a half bytes, while a week's worth of activity on a loaded system consumes just under 1 GB.

There are a number of intrinsic properties one might retain about individual storage requests, including: file name, file offset, request type, request size, disk address, time of issue, and time of completion. There are also less obvious characteristics one might be interested in, such as whether or not the request was served from cache or whether it incurred metadata IO. In an embodiment, utilizing the data shown above, workloads over periods of days and weeks are used to reconstructing coarse-grain temporal features; the use of other metadata or other intrinsic properties or characterizations in other embodiments could show a higher detail of temporal features. The use of the data above is intended to be illustrative, and embodiments are not limited to these characteristics and any others which may be available can be used to reconstruct such temporal features.

In some embodiments, a single high-fidelity, uncompressed trace record in this format would consume 26 bytes of storage, which may be too costly for always-on tracing in some systems. The size of records can be reduced in some embodiments by using one-second resolution time stamps and discarding latency details. This brings the size of an uncompressed record down to 18 bytes. This and other compaction techniques may be employed to both reduce the size of the individual or aggregate traces, but also to improve performance relating to the collection and storage (or logging) thereof.

In addition, embodiments may leverage that fact that storage workloads are commonly bursty and often exhibit runs of sequentially addressed requests to perform some simple domain-specific compaction techniques. In particular, timestamps of data requests can be stored as relative deltas rather than absolute values; at lower resolutions, this allows nearly all timestamps to be stored with one byte rather than four. Similarly, spatial locality can be exploited by chunking trace records by file handle and storing sequential addresses as deltas rather than absolute values. For MSR traces, it has been found that 15% of requests can be compressed in this manner. Finally, it has also been found in embodiments that the distribution of request sizes is very heavily skewed to a small number of common values. In MSR traces, a preponderance of requests (over 90%) exhibit one of a small number of sizes, making this property particularly well-suited for dictionary compression. Trace records are saved on disk in segmented files. Each variable-sized segment contains a file identifier index, a time index, a size dictionary, and one or more file record streams. The file index is keyed by an eight-bit identifier and contains ASCII representations of all the file names referenced in the segment as well as the segment offsets of their corresponding record streams. The time index contains the absolute time at which the first request in the segment was issued and an array of (e.g. file ID, time delta) tuples for each subsequent request. This is followed by the size dictionary, a table of the eight most common request sizes in the segment. Finally the trace records for each individual file are stored consecutively in the file record streams. The maximum size of a segment is limited by the fixed lengths of the index keys; in practice, the time index is typically limited to 64K entries, making it manageable to load entire segments in memory while still obtaining good per-segment compression. Experimenting with MSR workloads, an entire trace can consume 4.1 GB when stored in raw binary records compressed with bzip2. When stored as compressed, abbreviated records, the space consumed is reduced to 1.3 GB. The domain-specific compaction techniques mentioned above typically further reduce the final size by roughly 20%, allowing the storage of 417 million trace records in just under 1 GB. Nearly 80% of the compressed trace is attributable to the four busiest workloads, roughly in proportion to their share of overall IOPS, and compression rates vary by workload, ranging from 1.4 to 2.7 bytes per record. Assuming records are compressed in memory and written to disk in segments of roughly 200 KB, tracing a live system would incur approximately 15 additional IOPS per million recorded, a negligible performance overhead. And since the storage burden is also reasonable for modern deployments, the cost of continual system tracing is a fair price for the benefits that detailed workload histories can provide.

### Analysis Functionality

On one or more of the CPUs in the storage nodes, or alternatively at the centralized data management module on a network switching device, the aggregated data traces are analyzed to determine whether and how the data traces may be classified, or alternatively, if there are groups of data traces that indicate a relationship between data requests. In some embodiments, the analysis functionality is provided by a data analysis daemon. The data analysis daemon receives data from each TracerD, or alternatively the aggregated data, and attempts to classify the data requests and provide strategies or predictions about how the underlying data requests should be treated. In some cases, it is trying to balance the reactiveness to changes in the data versus effort on the system that is required as a result of such reaction. In prior art systems, classification typically occurs on the basis arbitrary sized “chunks” of data, for example 20 MB, having some portion of data therein which can be designated as “hot” (because, for example, it was not at the bottom of an LRU table); in such prior systems, contiguous chunks of the same size are grouped or associated with these chunks and the groups of chunks were then promoted to cache or to storage resources higher in the tier hierarchy. In prior art systems this was irrespective of whether the portion of “hot” data in the chunk was large relative to the size of the chunk, and the grouping was based on an often incorrect assumption that contiguous data chunks hold related data to that “hot” data; as such, current means of associating data with storage elements is doubly problematic. In many cases, related data is not stored in contiguous locations in storage. This may be particularly true in systems utilizing virtualized or distributed memory resources, which present a single logical storage unit that is in fact made up of a plurality of distributed physical storage units.

In instant embodiments, the analysis functionality can associate highly granular regions of data storage that contain the data related to aggregated data traces, and then associate such regions (or data thereon) with other regions that are storing related data. In some embodiments, the relationship may indicate that the data is temporally related: this means that when there is a data request relating to one of the regions, the memory system is able to predict or know that the data on the related storage region will likely be needed, and therefore both regions can be promoted. While a temporal relationship may be determined in the above example, other relationships may be determined. Other shared data characteristic may allow the data analysis daemon to determine a relationship between data. For example, certain shared characteristics may permit the data analysis daemon to determine that data requests from a particular requestor at a particular time may require higher levels of security and thus should be stored on more secure storage resources. In other cases, shared characteristics may indicate high multi-user access at specific times, which would indicate that in addition to a requirement for lower-latency because of a temporal relationship, specific precautions to ensure consistency of data be utilized since there are many users that could be making writes/updates to the data. In general, any shared characteristics of two or more data units will indicate that the data units should be stored in a particular manner to increase the likelihood of achieving a particular operational objective.

In some embodiments, the data-related characteristics include, but are not limited to: data addresses, size of requested data, time of request, existence of temporally or spatially related requests (indicative of bursts of related requests), latency, requestor identity, source of request, and metadata. Many NFS systems will be limited to this data as the node or network switch (having some level of centralized management) will only have access to this data and will lack visibility to other data, such as the metadata of the database or data client making the request. Other file systems or data systems, including some implementations of NFS, may provide such visibility and therefore other embodiments are enabled for assessing other metadata that relates to the data underlying the request. For example, it may be possible in such embodiments to have visibility to the metadata showing that a data request is related to access credentials, which at particular times during the day will be heavily accessed and may be considered to be “hot” data at those times, but otherwise should be consider to be “not hot” (i.e. of lower priority) irrespective of the fact that such data may have been called very frequently and very recently. In other cases, some data-related characteristics may be determined based on collected or accessed information.

The data analysis daemon in some embodiments is configured to assess the existence of shared characteristics between a first data request and at least one other data request. By linking the first data request to the at least one other data request, the first data request becomes part of a data cluster that includes the at least one other data request. The cluster is also associated with the shared characteristic(s) and/or the relationship (e.g., temporal relationship, sensitivity relationship, etc.). This information is made available to the Data Placement Functionality.

In embodiments, various techniques are used to define access clusters. One such exemplary methodology for computing those clusters from the traces and storing them efficiently on disk is disclosed hereafter. The clustering approach detailed below is but one of many possible ways to successfully divide blocks in a trace associated with related data into groups with similar temporal behavior. Access clusters, or data clusters, may be understood as groups of disk blocks with similar access patterns over time. In one embodiment, the access pattern of a disk block can be described to be a time-series vector x with m dimensions for each unit epoch over a span of time. The value for the j^{th} dimension of the vector, xⱼ, is determined by the number of read and/or write requests during the j^{th} epoch. These block request numbers can differ substantially across vectors, often by several orders of magnitude, enough to distort analysis calculations like vector normalization and similarity. To correct for this potential distortion, the entries in each vector may be log scaled to be \tilde{x}ⱼ=log(xⱼ+1). Furthermore, the log-scaled vectors are normalized to x̅=∥\tilde{x}∥₂ to correct for any distortion of similarity induced by differing magnitudes between two vectors. The set of all access patterns forms the access pattern matrix X, whose i^{th} row stores the access pattern of the i^{th} block.

Access pattern vectors reside in a high-dimensional space with hundreds or thousands (or more) of dimensions. Data points residing in high-dimensional spaces often present difficulty to classification and clustering algorithms due to both their computational complexity and the so-called curse of dimensionality. In embodiments, the dimensionality of this space may be reduced to mitigate such problems. Because the matrix X is nonnegative, embodiments may use a technique called Nonnegative Matrix Factorization or NMF to produce a low-rank approximation of the X. Using NMF, each access pattern corresponds to a linear combination of a small constant (10 or 20) set of basis vectors representing common features in the data. Each access pattern can then be represented by the coefficients of these features, reducing the complexity of distance calculations from O(m) to O(1).

In other embodiments, rather than use dimensionality reduction to reduce the computational complexity of our data, the sparsity of the access patterns themselves may be leveraged. An observation of long periods of inactivity between most block requests may indicate that most of the dimensions in the majority of access patterns in our data are zero. In one embodiment, there may be observed representation of normalized access patterns as sparse vectors with a small number, O(1), of nonzero entries on average. This sparsity can greatly reduce the average complexity of similarity calculations between two vectors in an access pattern matrix from O(m) to O(1).

There are a wide variety of distance metrics for determining the similarity between two vectors. Some embodiments may select from measures that consider two access patterns to be similar if they possess commensurate request magnitudes during roughly simultaneous epochs. Some embodiments may further or otherwise select a measure that can be efficiently computed across potentially many millions of different vectors. The cosine similarity metric, which measures the inner-product between two normalized vectors, d( x̅, y̅)=Σᵢ x̅ᵢ, y̅ᵢ, conforms well to these specifications. For two nonnegative vectors, it not only measures how many dimensions co-occur between the two vectors, but it also accounts for the magnitude at those intersecting times. Computationally, cosine similarity matrices of sparse, high-dimensional data matrices can be efficiently computed using an index structure such as an inverted file.

Equipped with a similarity metric and a set of vectors, an automatic clustering can be performed using one of a variety of possible algorithms, many of which that would be known to a person skilled in the art of data mining, even after filing, can be utilized without departing from the scope of this disclosure. In embodiments, the k-means algorithm may be used, which iteratively partitions blocks into k clusters while minimizing the distances to the cluster centroids. In embodiments, the following exemplary pseudocode listing of cluster data structures may be used to store access cluster information and metadata.

```
Usage {
  time_t time;
  int reads;
  int writes;
}
BlockPartition {
  long offset;
  int bytes;
  Usage[ ] usage;
}
Cluster {
  BlockPartition[ ] partitions;
  int[ ] acf;
  int[ ] sig_epochs;
}
```

Some embodiments will use, for identifying clusters of traces, the single-link hierarchical clustering algorithm for being O(N log N) to calculate using an index-structure approach, and resistant to outlier data points. In single-link, clusters are formed from the connected components of the graph whose vertices are blocks and whose edges are formed between any pair of blocks with access pattern similarity greater than some predetermined or measured similarity threshold. In addition to single-link, other clustering techniques can be used such as described by Voorhees (VOORHEES, E. Implementing agglomerative hierarchic clustering algorithms for use in document retrieval. Information Processing & Management 22, 6 (1986), 465-476, which is incorporated herein by reference). In embodiments, clustering of the web 2 MSR disk trace using the single-link approach with a threshold of similarity 0.8 was performed. In embodiments, different thresholds can be used, although there may be a tradeoff with respect to cluster size and fidelity.

Different embodiments may use differing data structures that (i) store cluster information differently, and (ii) use or facilitate different methodologies for how temporal metadata for each cluster is determined. The methods disclosed herein for such storage and determination are illustrative and other methods may be used. The methodology step below is one example in deriving useful information from cluster access history to improve cache policy decisions over the standard approach. The following table shows an example of possible information pulled from various VMs (virtual machine implementing a file system across distributed data resources) in a distributed data storage system. Per-VM statistics of clusters generated using an exemplary methodology in data analysis are shown. VM gives the name of the environment, # indicates the number of clusters generated, Addrs % represents the percentage of the blocks in the trace that are clustered, IOPS % represents the percentage of the IOps in the trace that request a clustered block, Mean and Median indicate the mean and median cluster size, and Seq % indicates the clustered blocks consisting of sequential accesses.

| | | | | Mean | Median | |
|---|---|---|---|---|---|---|
| VM | # | Addrs % | IOps % | (MB) | (MB) | Sparsity % |
| hm | 26 | 11 | 29 | 29 | 20 | 15 |
| mds | 30 | 2 | 10 | 68 | 24 | 16 |
| prn | 79 | 3 | 17 | 76 | 11 | 15 |
| proj | 99 | 58 | 63 | 7430 | 266 | 22 |
| prxy | 6 | 4 | 0 | 85 | 9 | 28 |
| rsrch | 1 | 1 | 7 | 8 | 8 | 0 |
| src1 | 57 | 23 | 33 | 1060 | 555 | 18 |
| src2 | 20 | 3 | 13 | 96 | 157 | 15 |
| stg | 22 | 89 | 86 | 3840 | 701 | 22 |
| ts | 4 | 1 | 12 | 8 | 10 | 0 |
| usr | 149 | 46 | 41 | 3290 | 57 | 20 |
| wdev | 4 | 1 | 20 | 5 | 6 | 36 |
| web | 88 | 45 | 39 | 488 | 89 | 24 |

In some embodiments, metadata regarding each cluster may be stored in memory. In some cases, there is maintained, in respect of data clusters, three lists: a list of block partitions in time, a list of strong autocorrelations, and a list of significant epochs. An epoch is generally understood to refer to a time period. A block partition may be characterized as a set of sequential blocks in a cluster who, when ignoring the vector magnitudes, have identical access patterns. A block partition maintains the base address of the partition, the size of the partition in bytes, and a list of access usage entries. Each usage entry contains the time of the epoch in which all blocks in the partition appear, as well as the number of reads and/or writes to those blocks during the epoch. The list of cluster autocorrelations are derived by first calculating the centroid of the cluster, the mean vector of each access pattern appearing in the cluster. Given the cluster centroid, we compute the autocorrelation function for its access pattern vector. The autocorrelation for time t of an access pattern measures the correlation of set of pattern entries with the set of pattern entries t epochs away. Informally, this provides a rough measure of the dependence between cluster activity across time. Those lags whose autocorrelation exceeds 0.3 are selected to add to the autocorrelation list. Significant epochs are those intra-day epochs with cluster activity across multiple days. These are calculated by measuring the fraction of cluster blocks accessed in an epoch across multiple days. Epochs with a large fraction of cluster access provide evidence of a daily temporal dependence.

Autocorrelations provide a relative measure of cluster activity through time, while significant epochs provide an absolute measure of cluster activity through time. Both of these strategies can be leveraged to estimate the forward distances of a cluster. Here, forward distance refers to the estimated LRU (“Least Recently Used”) stack distance of a cluster at its next access. Other approaches, such as spectral density estimation, may provide a more reliable relative activity measure of the future.

### Data Placement Functionality

On one or more of the CPUs in a storage node (i.e., the data server in this embodiment), or alternatively at the centralized data management module on a network switch, the data routing functionality determines to where data requests that are associated with a data cluster should be directed or migrated.

In current embodiments, data requests are cross-referenced with a table that describes and/or holds data clusters or references to data in data clusters. Once an association with a cluster in the table is determined, the data request can be properly directed or migrated or placed. The data that relates to the data request can be placed on the storage resource that best fits the operational needs associated with priority characteristics of that data. “Hot” or live data should be forwarded to flash memory and less-live data should be on hard drive disks. Data belonging to clusters can be placed in advance on the most appropriate memory, and pre-fetches for related data (i.e. belonging to the same cluster) can be initiated before the data is even requested.

Other functionalities that become possible with the data stored in the logging module, and the methods and devices of analysis described herein include: a. summarizing clustered data, and the associated metadata, to save space in the storage system, and then communicate them back in order to monitor storage system health.; b. perform application/vm workload analysis, including the characterization of working set size and miss ratio curve (which may be used to guide reconfigurations to client applications, e.g., provide an indication to an administrator that she should add more RAM to avoid paging at high rates, or to indicate when the customer should beneficially add additional storage hardware of a particular performance); c. used for constructing workload-, or data-specific performance heuristics, including caching/tiering policy, prefetching, and placement decisions. Other functionalities may include (a) an efficient in-datapath tracing mechanism with lazy writeout, (b) the use of free space as “dark storage” to store logs for free, (c) the use of compression, digesting/summarization, as well as other known methodologies to “compact” data in that free space when it comes under pressure, (d) an embedded interface to do time-series data analysis on logs that is scaled out across all CPUS/disks in the clustered store, (e) use with applications of that interface to calculate useful performance data and feed them into parts of the system that use them. This can be drill-down performance reporting, notification for administrators regarding specific performance issues and related assessments, such as Working Set Size (“WSS”) analysis.

Embodiments described herein support a number of non-limiting ways in which temporal metadata can be used to improve existing storage systems. The following exemplary embodiment shows a week-long collection of storage traces that are typical of a small- to mid-size enterprise data center. The traces record the disk activity (captured beneath the file system cache) of 13 servers with a combined total of 36 volumes. Notable workloads include a web proxy, a filer serving user home directories, another serving project directories, a media server, and a pair of source control servers. In general, the workload is read-heavy, random, and bursty. Over the entire trace, approximately 8.5 TB of data is read from 736 million unique block addresses and 2.3 TB of data is written to 95 million unique block addresses. Roughly 15% of requests are sequential (where sequentiality is defined as two or more back-to-back requests referencing contiguous block addresses). Many of the workloads feature pronounced diurnal patterns, with large bursts of activity occurring at regular times of the day. Most recurring accesses follow each other within minutes, but the distribution also features a long tail of requests that do not exhibit strong temporal locality. There is an evident bump in re-write intervals around one minute, presumably due to periodic flushing of file system metadata, and a few specific workloads show very prominent re-access patterns; in particular, in the table below src1 features a notable 24-hour write cycle,

Through the use of Mattson's stack algorithm, the behavior of these workloads across a spectrum of LRU cache sizes can be evaluated. For each workload, the table below exemplifies VM's having computed miss ratio curves (MRCs) for all possible cache sizes, considering only read requests. Most workloads feature a prominent MRC elbow, beyond which additional cache capacity yields diminishing returns. The table below shows the cache sizes at these elbows and the corresponding hit rates for all workloads. The workloads exemplified in the table below show interaction with traditional LRU caches in very different ways: mds, a media server, features a large proportion of sequential scans that are not amenable to demand-fault caching; stg, a web staging server, features a large burst of reads early in the trace, which, given a cold cache, result in a poor hit rate for the full week; and prxy, a web proxy and firewall, issues 37% of all the reads in the entire trace and exhibits exceptional spatial locality (even at limited cache sizes, its high frequency, low volume workload results in high hit rates). While most of these workloads shown below exhibit reasonably high hit rates when considered in isolation, some of them suffer when they are combined in a fixed size cache. In particular, bursty, out-of-phase workloads do not behave well together. For example, in the servers listed below, web2, which features highly localized bursts of activity once every 24 hours, can obtain a hit rate of nearly 50% from an isolated 40 GB LRU cache. But when combined with competing workloads, its long periods of dormancy cause its pages to be evicted from the cache before it has a chance to re-read them, resulting in a poor 6% hit rate with a shared 512 GB cache.

| | Cache | |
|---|---|---|
| Workload | Size (GB) | Hit Rate |
| hm | 10 | 91% |
| mds | 2 | 10% |
| prn | 161 | 64% |
| prxy | 73 | 99% |
| rsrch | 0.25 | 83% |
| src1 | 4332 | 93% |
| src2 | 25 | 45% |
| stg | 6 | 15% |
| ts | 1 | 90% |
| usr | 9480 | 62% |
| wdev | 0.4 | 96% |
| web | 354 | 75% |
| combined | 10208 | 79% |

In an exemplary embodiment, a log-structured cache with 4K blocks and 2 MB log segments were utilized. The distributed hybrid storage system comprised 13 server workloads which are served from the same cache, and both reads and writes are considered. In operation, exemplary systems start with a cold cache, which caps the highest achievable demand-fault hit rate for workloads at, in some cases, 74%. In some embodiments, there would be at least a few weeks of workload history with which to train the clustering algorithm. When attempting to classify the longer-term temporal characteristics of a workload, it is extremely useful to include multiple weekends in the training period, as access patterns vary significantly during non-working hours. Moreover, it has been shown in some embodiments that longer training periods help filter outliers and produce more accurate clusters. The first two and a half days were used in this example to generate the initial set of clusters, and begin all experiments at the start of the third day. At the end of each day, new clusters were generated incorporating the day's workload, so that by the last day of the trace, there were clusters derived from a six day training period.

Instantly disclosed embodiments leverage extended workload histories to identify potentially non-contiguous block clusters that share common access patterns, and once identified, information about these clusters can be used to proactively schedule the migration of data between tiers. In embodiments, a tier management system is designed as an independent module that can be combined with existing cache eviction policies. It maintains a balanced tree of well-known clusters sorted by their predicted forward distances. It intercepts the stream of requests issued to the cache manager, and maintains an independent LRU-ordered list of accessed blocks for each cluster. It uses these lists to provide hints to the cache manager about blocks that are good candidates for eviction by nominating the LRU blocks of clusters with high predicted forward distances. This strategy allows the cache to aggressively de-stage workloads that exhibit prominent periodic characteristics (such as nightly virus scans), which could otherwise consume cache space for much longer than required.

Some embodiments may also implement informed prefetching. While a high degree of randomness may indicate poor responsiveness for simple sequential prefetching, some of the workloads do exhibit strong non-linear temporal locality, which is captured by the clustering algorithm used in embodiments. In such cases, this is leveraged by conservatively prefetching clusters: if a read fault references a block associated with a cluster, and the time of the fault corresponds to the predicted forward distance of that cluster, the tier management system schedules the rest of the cluster to be brought into the cache. This improves the speed with which workloads can be moved in and out of the cache, helping the system respond to workload phase changes.

Embodiments of storage systems, devices and methods disclosed herein, can take advantage of extended workload histories to make informed decisions when serving current workloads, leading to smarter use of contended resources and improved performance. Workload histories can also be useful for storage administrators by aiding in the diagnosis of problematic work-loads and suboptimal configurations. The provisioning of storage deployments can be a challenging problem involving tradeoffs between performance, capacity, and cost requirements. A common approach is to overprovision systems based on an estimation of peak performance requirements. This strategy is vulnerable to changes in workloads, but storage administrators often have limited data points to draw upon when evaluating the health of running systems. Metrics like cache hit rate can be misleading, as in the case of the MSR traces, where a single misconfigured client contributes a disproportionately large number of read hits, driving up the overall hit rate and masking the fact that other workloads are suffering. Moreover, while low hit rates or high latencies might indicate problems, they do not provide direct insight into what the best solution might be. For instance, no amount of additional cache capacity will improve the performance of large sequential scans (barring prefetching) and other poorly-behaved workloads.

In some embodiments, the use of data compression (which may be considered to be a subset of compaction in some cases) can be used to increase overall system effectiveness. It is often the case that a portion of data stored in a data storage system (whether distributed or not) is essentially archival: it needs to be retained, but will almost never be accessed or it will be accessed extremely infrequently. In other words, it is of extremely low priority. If this extremely low priority data can be identified, the cost of storing it can be reduced by combining it with like low priority data stored by other clients, and/or defragmenting it, and/or compressing it. This re-organization could be done in the background, and it would allow the system to effectively expand the system's capacity at the expense of slower access times to archival data (which would require decompression on the data path). This may be accomplished in some embodiments by setting a third priority threshold and re-organizing such data depending on whether the priority of certain data drops below the third threshold.

In a given deployment, a specific client or set of clients may tend to frequently access a specific set of data (periodically or continuously). In such cases, it can be advantageous to migrate the data to the server nearest the clients or the clients with the fewest hops therebetween. This one-time bulk transfer of data across servers would reduce network traffic when clients access data. Alternatively, if there is no particular affinities detected between data sets and specific clients, migration can be used to improve load balance by distributing particularly hot data across all nodes in the distributed storage system such that each node serves roughly the same quantity of hot data (in some unit combining both capacity and IOPS). Moreover, if the performance of a particular server drops (e.g., it is experiencing higher than normal request latencies), this may be treated as an indication that the server is overloaded, or perhaps suffering from faulty hardware. In either case, moving data off of that server onto healthier nodes may be warranted until the performance of that node has returned to expected levels.

For high priority data, the replication factor can be increased to store copies on additional nodes. This would trade capacity for performance by allowing clients to access the data directly from the node they connect to, reducing network traffic and request latency. As workloads change and hot data cools, its additional replicas could be removed to reclaim capacity. Data that is read much more frequently than it is written would experience operational benefits from such duplication.

If an analysis indicates that there is a performance constraint due to a lack of low latency memory, such as flash, it would be possible to notify the storage administrator to make a decision on whether or not to expand the available memory resources. Historically, it has been difficult to determine with high confidence that a workload is performance-constrained just by inspecting historical traces. One reason for this is that even if it can be determined, for example, that the data is hitting the slower tiers more often than would be optimal, it has been very difficult to estimate exactly how much performance could be improved simply by adding more flash. With adequate analysis of working set size, it is possible to assess with reasonable confidence whether or not the disk-tier bottleneck can be eliminated by adding more flash. At any rate, simple heuristics such as comparing current flash miss rates to historical rates and watching for changes in request latency would at least allow the administrator to determine that performance is degrading and additional flash may be required.

It is likely that comprehensive workload traces lose value over time. For instance, a record of every request in the past week is probably more valuable than a record of every request from a week one year ago. As traces age, lossy compression techniques can be applied to retain important high-level characteristics while reclaiming some of the space required to store the traces. These digests could be used to improve the analysis module's resiliency to bursty workloads, and they can also be used to provide users with historical performance data. Such history might make clear, for example, that a certain deployment exhibits decreased load at certain times of the year, and that an administrator could safely power down machines during those periods to save energy without affecting performance.

In embodiments disclosed herein, techniques and processes are disclosed for assigning certain data to certain storage resource types in a manner that optimizes operational benefits. For example, data that needs to be accessed frequently and/or quickly (“hot” data) should be placed on low-latency/high-performance memory, which is typically expensive, e.g. flash, and data that changes or is accessed infrequently (“not hot” data) should be stored on cheaper but lower performing disk storage. Determining which of this data is which is challenging. For example, large data sets that have “bursty” access requests will generally be deemed to be “not hot” but during times of high or rapid access it will be “hot”, which leads to a mischaracterization during times of lower or infrequent access and placement on incorrect storage types. Some embodiments of these analysis techniques may minimize the processing requirements of tracking and analyzing data requests for optimal characterization of the related data.

Embodiments herein leverage fast computational resources, and larger fast memory on storage nodes, to log every access and persist that log to free space. This logged data can effectively be “dark storage” that is persisted on an opportunistic basis but can also be used to optimize or maintain storage resources. Specific uses of the logged data can be used by idle computational power to do many useful things, including but not limited to: a. summarizing digests of logged historical data to save space, and ship them back in order to monitor customer health.; b. perform application/virtual machine workload analysis, including the characterization of working set size and miss ratio curve (which may be used to guide reconfigurations to client applications, e.g. add more RAM to reduce paging rates, or to indicate when the customer should beneficially add additional storage hardware and what type of storage this should be); c. used for constructing workload-, or data-specific performance heuristics, including caching/tiering policy, prefetching, and placement decisions.

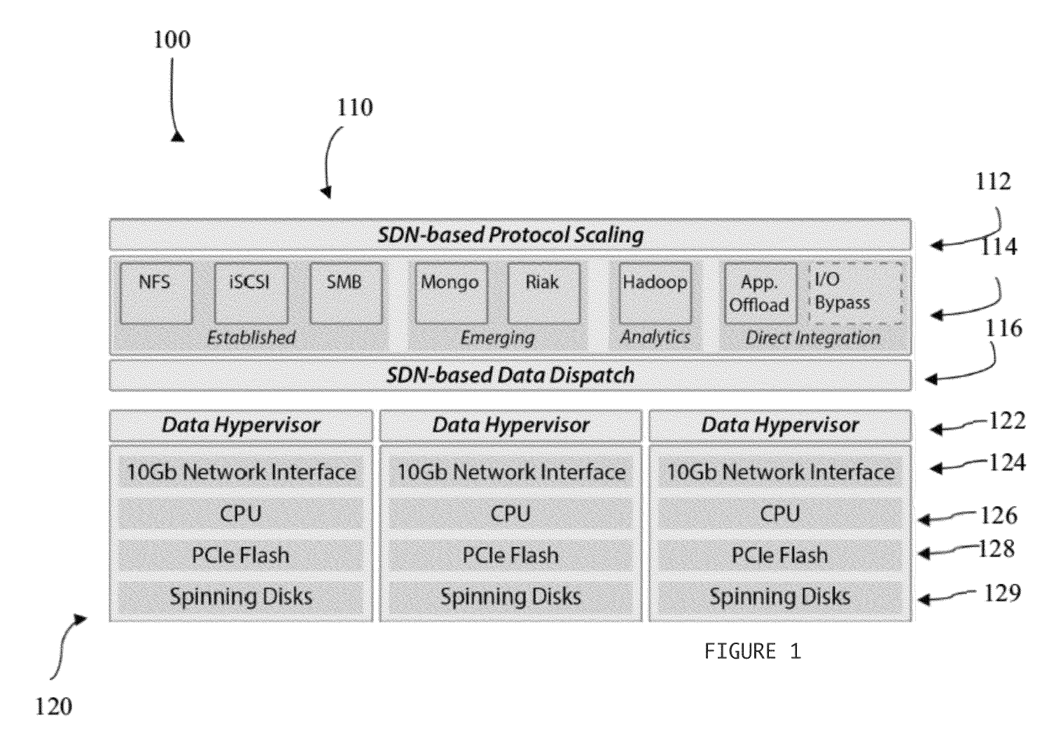

Referring to FIG. 1, which illustrates an architecture of one embodiment of the functionalities in a distributed storage system 100 described herein, there is provided an SDN-based data-path protocol integration module 110, which comprises a protocol scaling module 112, an SDN-based data dispatch 116, and an SDN-based data interaction module 114. In embodiments, the data-path protocol integration module 110 is a set of functionalities which are handled by an SDN network switch (not shown). The switch handles data transactions between data clients and storage nodes in the distributed data storage system. In FIG. 1, there is shown in the SDN-based data interaction module representative protocols which may be handled at the switch by performing certain transport-, session-, presentation- and application-layer functionalities in various data personality APIs (based on existing models/applications/protocols or customized proprietary models/applications/protocols), thus permitting a closer integration to the storage system. There is also shown in FIG. 1 an exemplary set of storage nodes 120. Each storage node 120 comprises of a 10 GB network interface 122, a CPU 126, a set of one or more PCIe Flash date resources 128, and a set of spinning disks 129. Each storage node also has stored therein, and implemented by the local CPU 122, a hypervisor 122 that communicates with the operating system on the storage node upon which it resides, as well as the hypervisors and/or operating systems of the other storage nodes, to present virtual machines that present as a logical storage unit to data clients.

The design of the system 100 divides storage functionalities into two broad, and independent areas. At the bottom, storage nodes 120 and the data hypervisor 122 that they host are responsible for bare-metal virtualization of storage media 128, 129 and for allowing hardware to be securely isolated between multiple simultaneous clients. Like a VMM, coordinated services at this level work alongside the virtualized resources to dynamically migrate data in response to the addition or failure of storage nodes 120. They also provide base-layer services such as lightweight remapping facilities that can be used to implement deduplication and snapshots.

Above this base layer, the architecture shown in FIG. 1 allows the inclusion of an extensible set of hosted, scalable, data, personalities that are able to layer additional functionalities above the direct storage interfaces that lie below. These personalities integrate directly with the SDN switch and, in some cases, may be hosted in isolated containers directly on the individual storage nodes 120. This approach allows a development environment in which things like NFS controller logic, which has traditionally been a bottleneck in terms of storage system processing, to transparently scale as a storage system grows. The hosted NFS implementation in the embodiment shown runs on every single storage node 120, but interacts with the switch to present a single external IP address to data clients.

The interface between these two layers again involves the SDN switch. In this situation, the switch provides a private, internal interconnect between personalities and the individual storage nodes. A reusable library of dispatch logic allows new clients to integrate onto this data-path protocol with direct and configurable support for striping, replication, snapshots, and object range remapping.

Dividing the architecture in this manner facilitates increased performance, scalability, and reliability right at the base, while allowing sufficient extensibility as to easily incorporate new interfaces for presenting and interacting with your data over time. The architecture of FIG. 1 presents one or more of an NFS target for VMware, Hadoop-based analytics deployment directly on your stored data, general-purpose, physical NFS workloads, and HTTP-based key/value APIs. Other application-layer functionalities may be implemented at the data-path protocol integration module 110 without departing from the scope and nature of the instant disclosure. In some embodiments, enterprise users may elect to integrate their in-house applications directly against the data personality APIs, allowing their apps to interact directly with the bottom-level storage nodes 120 and reducing protocol, library, and OS overheads.

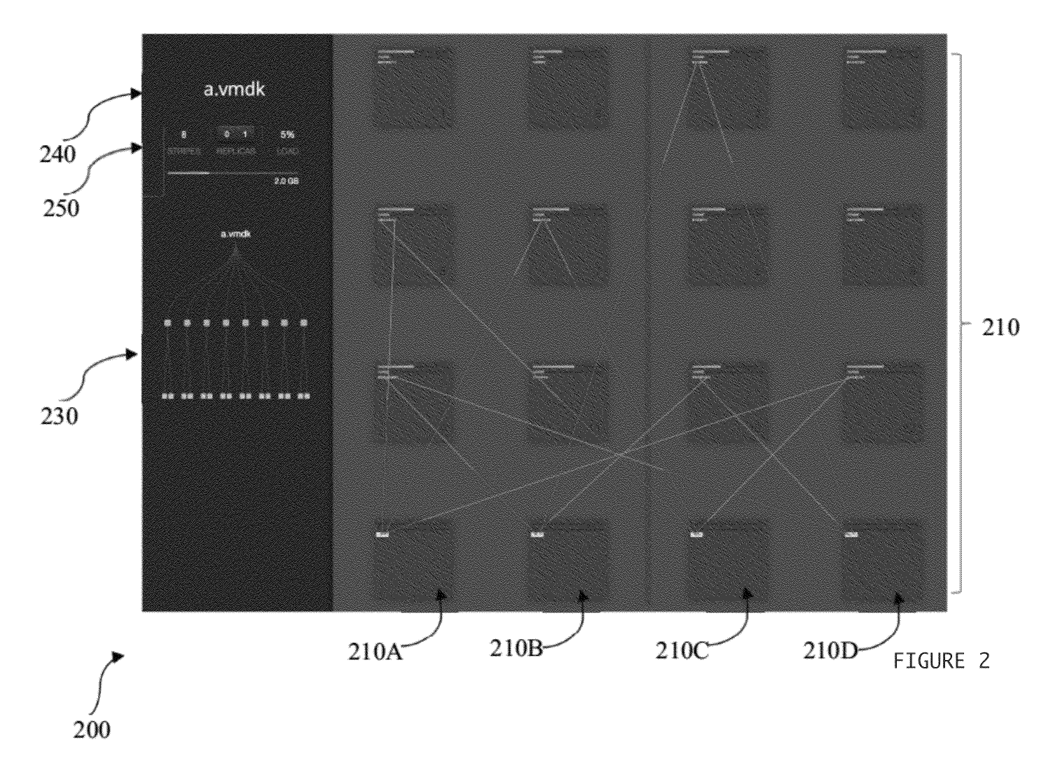

Referring to FIG. 2, there is provided a representative diagram of a set of storage nodes 210 in distributed storage 200 (the switch, which may in some embodiments implement certain functionalities and serve as an interface between the storage nodes, is not shown). In the embodiment shown, there are 16 storage nodes 220. In this case, a data object, which is the file called a.vmdk 240, is being stored across the distributed storage 200. The status information bar 250 shows that a.vmdk 240 has been “striped” across 8 storage nodes. Data striping is a technique of segmenting logically sequential data, such as a data object or file, so that consecutive segments are stored on different physical storage devices. Striping may be useful when a processing device (e.g. a data client) requests access to data more quickly than a single storage node can provide. By spreading segments across multiple storage nodes, multiple segments can be accessed concurrently, which may provide greater data throughput, which avoids the processing device having to wait for data. Moreover, in this instance, each stripe has been replicated twice, as can be seen from the representative data diagram 230 showing how the storage of a.vmdk 240 has been across the storage nodes. Communications 220 from the storage nodes 210 shows how each of the replicated stripes have been distributed across the system of storage nodes 220. Should any storage node 210 fail or simply become slow or experience reduced performance, a replica stripe for a.vmdk 240 may be used and the storage nodes 210 can rebalance the storage of a.vmdk 240 to continually present optimal storage.

The data hypervisors on the storage nodes may operate in communication with one another to manage and maintain objects over time. Background coordination tasks at this layer, which can be implemented by logic located at the switch or on the storage nodes themselves, monitor performance and capacity within the storage environment and dynamically migrate objects in response to environmental changes. In embodiments, a single storage “brick” (which is used in some embodiments to describe the form factor of a commercial product) includes four additional storage nodes (i.e. a NIC, a CPU, one or more PCIe flash cards, and one or more 3 TB spinning disks). A balanced subset of objects from across the existing storage nodes will be scheduled to migrate, while the system is still serving live requests, onto the new storage nodes. Similarly, in the event of a failure, this same placement logic recognizes that replication constraints have been violated and trigger reconstruction of lost objects. This reconstruction can involve all the storage nodes that currently house replicas, and can create new replicas on any other storage nodes in the system. As a result, recovery time after device failure actually decreases as the system scales out. Similarly, data placement as a result of an indication that priority of a particular data cluster will increase or decrease in upcoming time period can be implemented across the higher (or lower, as the case may be) performing data resources which are available on other storage nodes across the distributed storage 200.

It is important to recognize that the placement of data in the system is explicit.

Old approaches to storage, such as RAID and the erasure coding techniques that are common in object storage systems involve an opaque statistical assignment that tries to evenly balance data across multiple devices. This approach is fine if you have large numbers of devices and data that is accessed very uniformly. It is less useful if, as in the case of PCIe flash, you are capable of building a very high-performance system with even a relatively small number of devices or if you have data that has severe hot spots on a subset of very popular data at specific times.

Further referring to FIG. 2 shows a web-based visualization of a running system in which four new storage nodes 210A, 210B, 210C and 210D have just been added. The data hypervisor's placement logic has responded to the arrival of these new storage nodes 210A, 210B, 210C and 210D by forming a rebalancing plan to move some existing objects onto the new nodes. The system then transparently migrates these objects in the background, and immediately presents improved performance and capacity to the system. The system 200 is configured to continually rebalance data clusters, which are deemed, based on the analysis techniques disclosed herein, to be of high priority (or alternatively, have low forward distance), onto those storage nodes that have PCIe Flash resources available. Conversely, data which has increased forward distance with distributed to the spinning disks available across the system 200 of storage nodes 210.

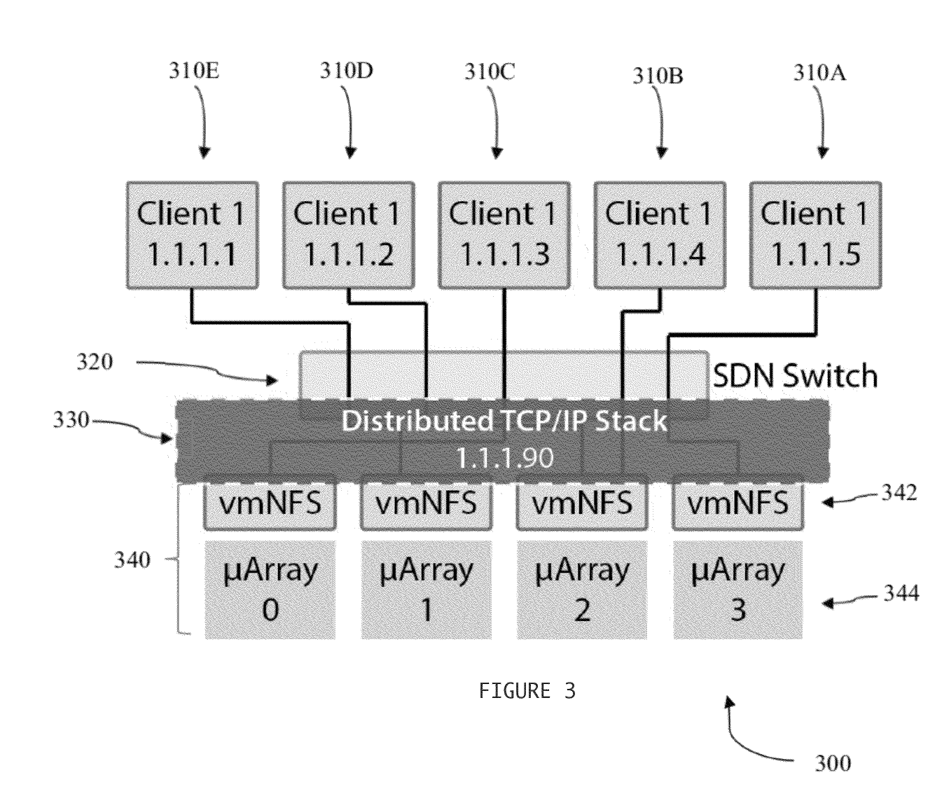

Referring to FIG. 3, there is shown a distributed data storage system 300. Data clients 310A, B, C, D and E are communicatively coupled over a network (not shown) to an SDN switch 320. The SDN switch 320 interfaces the data clients 310 with the storage array 340 and cooperates with one or more of the storage nodes 342 to distribute a single TCP/IP stack 330 and present the storage array 340 as a single IP address to the data clients 310. A virtualized NFS server 342 sits above the physical storage nodes 344. The SDN switch 320 and the vmNFS 342 cooperate to distribute NFS data requests across the storage nodes and also perform data migration to ensure that at any given time, data is stored on the tier of data storage resource that is most appropriate for the forward distance of that data (i.e. low forward distance data is stored on flash; high forward distance is stored on spinning disks).

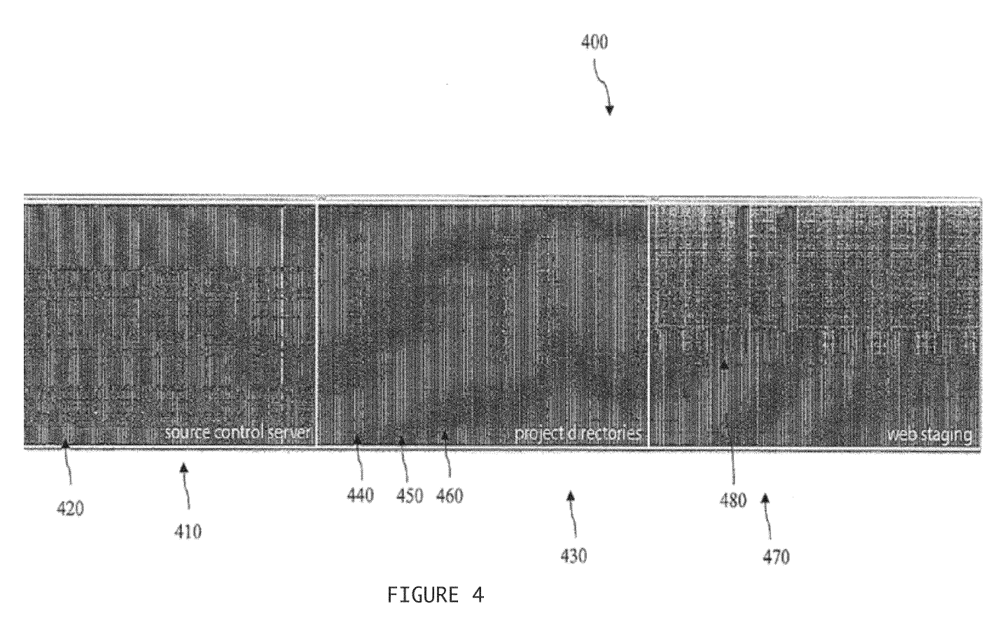

Referring to FIG. 4, there are shown time-series graphs of data transactions 400 to three different processes over a first time period (in this case, a prior 7 day period) 410, 430, 450. Access analytics is shown on three different storage workloads; time is on the x-axis for a one-week trace, and the y-axis indicates the disk's address space. Accesses are represented as a heatmap over time, where blue indicates read-heavy access and red indicates large numbers of writes. The first one shows data transactions (e.g. reads, writes and responses thereto) from a specific source control server 410. As can be seen in graph 410, there is a regular pattern of intensified data transactions for certain data occurring primarily at specific times (e.g. see the high access time interval 420 on the first day) multiple times every day across the week shown. Upon recognizing that clusters of data blocks have a tendency to be accessed with high intensity at those very regular intervals of time, the instantly disclosed subject matter determines the association between the blocks at which such data is stored and promotes that data to flash shortly before each time 420 and on to spinning disks in between those time. In some embodiments, the high frequency of the high access time intervals 420 may not warrant the constant transfer of the data back and forth. In embodiments, the administrator can assess the value of that trade-off based on the amount of data, the importance of performance for that specific data, the number of users, or other factors. In the graph showing project directories 430, a pattern of consistent data transactions involving data in specific blocks is shown across 5 of the 7 days shown. The higher access time interval 440 is accessed evenly across a time that is generally representative of the working hours on a business day. There is a pattern of markedly reduced data transactions 450, 460 which represent the time series data activity on a Saturday and Sunday. In the graph showing the time-series of activity on a web staging process 470, there is shown very heavy usage of some data used by the process, where other data is used more periodically 480. In this case, the high usage indicates data that should be considered for more or less permanent storage on higher performance data, whereas the more periodic data should perhaps be transferred back and forth between higher and lower performing data storage to reflect the times of high and low usage, respectively. In this case, the trade off from the burden on system resources from moving data from higher performing to lower performing storage resources, and vice versa, needs to be balanced by the performance gained from having the priority of the data matching the storage resource on which it is maintained.

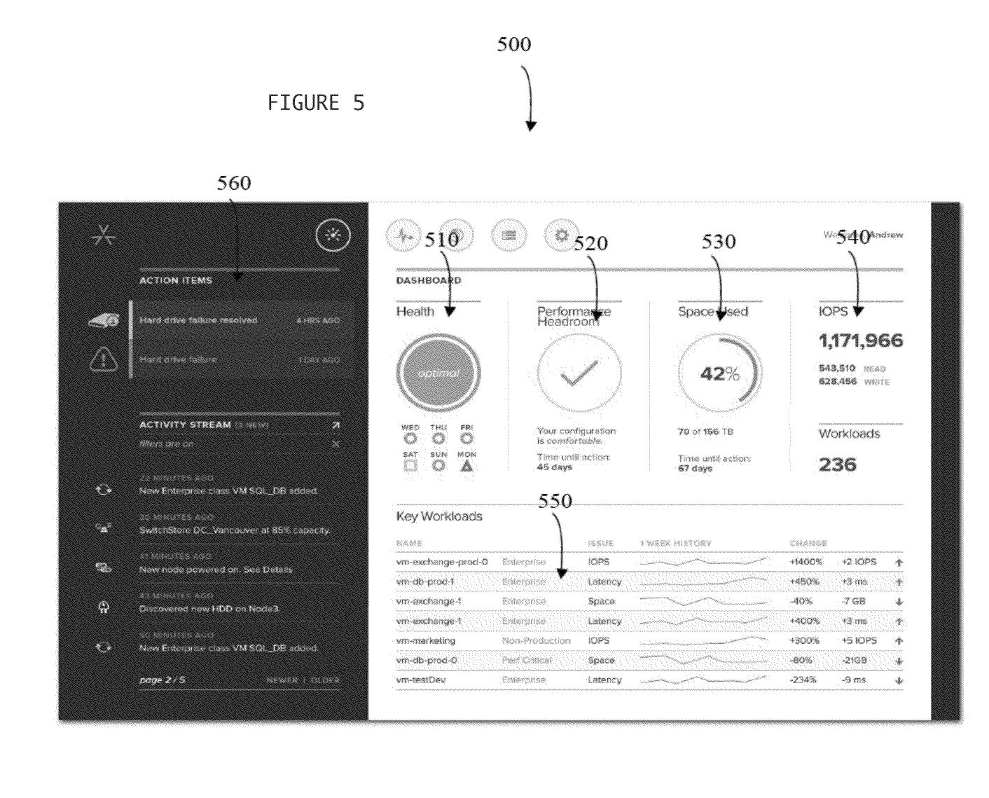

Referring to FIG. 5, there is shown a representative screen shot of the administrative control features 500 of one embodiment of the instantly disclosed subject matter. There is provided a quick graphical reference of the overall health of the system 510, the requirements for additional performance 520, capacity 530, and the number of operations per second currently being experienced 540, a reference tool split by workload (in this case virtual machines being run on the storage system) 550, and an indication of specific events occurring within the system 560.

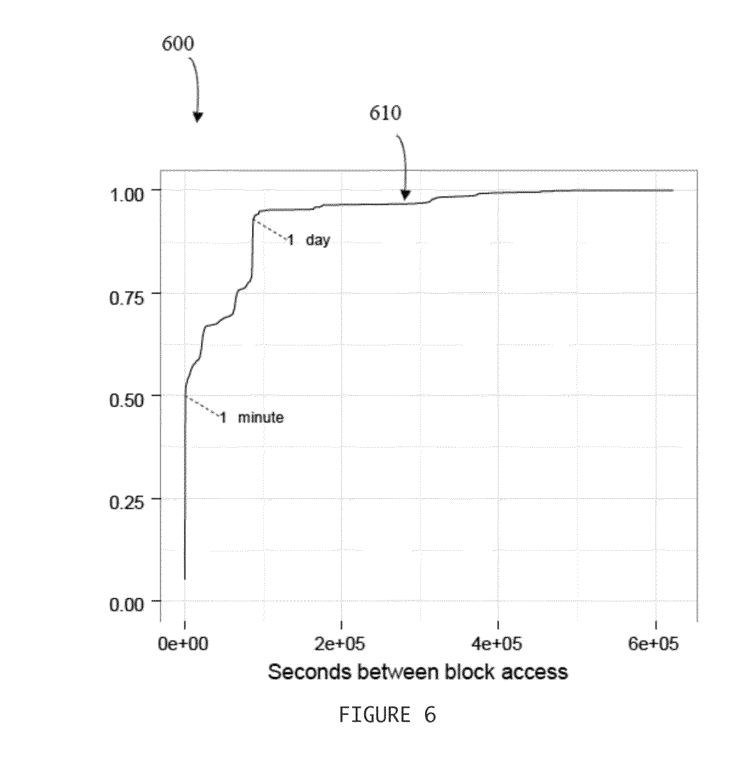

Referring to FIG. 6, there is shown a representative cumulative distribution function of times between accesses to trace blocks 600. The graph is generated by: from a sequence, A, constituted of requests to blocks on a disk over time, there is a further second sequence, B, of those requests to blocks that are requested more than once; for each block that refers to requests in sequence B, there is an unordered set of values that constitutes the time between subsequent requests to that block and this unordered set may be referred to as C. Computing the empirical distribution function, D, of the set of times C, we can generate the curve 610 shown in FIG. 6. The line 610 shows that there is a higher concentration of jumps in the CDF at two times: approximately 1 minute and 1 day. This indicates that the time distance between sequence has a high probability of being one minute apart or one day apart; this indicates a high priority at certain times, (i.e. when requests are one minute apart), for the blocks associated with requests in sequence A or B. It provides evidence, in light of the latter jump, that a substantial proportion of disk block requests occur at diurnal frequency. As such, the blocks associated with this analysis, should be moved to high-performance, high-throughput, low-latency disks at the times associated with the one-minute frequencies, but in lower-performing data at times between the instances of high-diurnal usage.

While the present disclosure describes various exemplary embodiments, the disclosure is not so limited. To the contrary, the disclosure is intended to cover various modifications and equivalent arrangements included within the general scope of the present disclosure.

What is claimed is:

1. A computer-automated method for prioritizing storage resource allocation in a data storage system having a plurality of networked storage resources, the method comprising:
processing a plurality of data transactions for corresponding data in the data storage system, each one of said data transactions having at least one data-related characteristic related thereto;
logging each said at least one data-related characteristic in association with a respective data transaction identifier respectively identifying each of said processed data transactions;
analyzing said logged data-related characteristics to identify at least one shared data-related characteristic shared within respective subsets of said respectively identified data transactions;
logically linking said respectively identified data transactions within each of said respective subsets as a function of each said shared data-related characteristic; and
prioritizing allocation of the storage resources for data corresponding to at least one of said respective subsets as a function of said shared data-related characteristic.

2. The method of claim 1, further comprising allocating the storage resources as a result of said prioritizing.

3. The method of claim 1, wherein said data-related characteristic comprises a time-dependent characteristic, and wherein said prioritizing comprises dynamically prioritizing allocation as a function of said time-dependent characteristic.

4. The method of claim 1, wherein said analyzing comprises identifying a high data access frequency for a given time period in at least partially defining a given data transaction subset, and wherein said prioritizing comprises dynamically prioritizing allocation of a high performance storage resource during said given time period to data corresponding to said given subset.

5. The method of claim 4, wherein said analyzing further comprises identifying another data-related characteristic shared within another subset overlapping said given subset, and wherein said prioritizing further comprises dynamically prioritizing allocation of said high performance storage resource during said given time period to data corresponding to said other subset.

6. The method of claim 1, wherein said analyzing comprises identifying a low data access frequency for a given time period in at least partially defining a given data transaction subset, and wherein said prioritizing comprises dynamically prioritizing allocation of a low performance storage resource during said given time period to data corresponding to said given subset.

7. The method of claim 6, wherein said analyzing further comprises identifying another data-related characteristic shared within another subset overlapping said given subset, and wherein said prioritizing further comprises dynamically prioritizing allocation of said low performance storage resource during said given time period to data corresponding to said other subset.

8. The method of claim 1, wherein said allocation comprises dark storage allocation to storage locations characterized by infrequent use.

9. The method of claim 1, wherein said logging comprises logging to persistent memory.

10. The method of claim 1, wherein said logging comprises compacting logged data.

11. The method of claim 1, wherein said data-related characteristic comprises a priority of said corresponding data, and wherein said analyzing comprises analyzing said priority at prior intervals during at least one prior time period.

12. The method of claim 11, further comprising, at subsequent intervals during a subsequent time period that correspond with said prior intervals, allocating to a lower latency data storage resource select data whose priority at said prior intervals was greater than a preset priority threshold value.

13. The method of claim 12, wherein said allocating further comprises allocating to said lower latency data storage resource further data whose priority at said prior intervals was lesser than said preset priority threshold value but whose logged corresponding data transactions are logically linked with logged data transactions corresponding to said select data based on said at least one said distinctly shared data-related characteristic.

14. The method of claim 11, further comprising, at subsequent intervals during a subsequent time period that correspond with said prior intervals, allocating to a higher latency data storage resource select data whose priority at said prior intervals was lesser than a preset priority threshold value.

15. The method of claim 14, wherein said allocating further comprises allocating to said higher latency data storage resource further data whose priority at said prior intervals was higher than said preset priority threshold value but whose logged corresponding data transactions are logically linked with logged data transactions corresponding to said select data based on said at least one said distinctly shared data-related characteristic.

16. The method of claim 1, wherein said prioritizing results in grouped data storage resource allocation prioritization for data grouped from disperse storage locations within the system irrespective of physical data storage proximity and data access recency.

17. A device for prioritizing storage resource allocations in a data storage system having a plurality of networked data storage resources and servicing at least one data consumer, the device comprising:
a plurality of ports for communicatively coupling the device to the plurality of data storage resources and the plurality of data consumers;
a switch to route data transactions for data on the data storage system between the plurality of storage resources and the plurality of data consumers;
a processor; and
a memory, said memory having instructions located thereon that when implemented by said processor cause the device to:
monitor said data transactions to extract at least one respective data-related characteristic therefrom;
log each said data-related characteristic in said memory in association with a respective data transaction identifier;
logically link data transaction identifiers into transaction subsets based on shared data-related characteristics; and
prioritize allocation of the storage resources for data corresponding to at least one of said transaction subsets as a function of said shared data-related characteristics.

18. The device of claim 17, said instructions further causing placement of said corresponding data based on said allocation.

19. The device of claim 17 wherein said data-related characteristic comprises a time-dependent characteristic, and wherein said prioritizing comprises dynamically prioritizing allocation as a function of said time-dependent characteristic.

20. The device of claim 17, wherein the memory further comprises instructions to identify a high data access frequency for a given time period in at least partially defining a given data transaction subset, and wherein said prioritizing further comprises prioritizing allocation of a high performance storage resource during said given time period to data corresponding to said given subset.

21. The device of claim 17, wherein the memory further comprises instructions to identify a low data access frequency for a given time period in at least partially defining a given data transaction subset, and wherein said prioritizing further comprises prioritizing allocation of a lower performance storage resource during said given time period to data corresponding to said given subset.

22. The device of claim 17, wherein said allocation comprises dark storage allocation to storage locations characterized by infrequent use.

23. The device of claim 17, wherein said data-related characteristic comprises a priority of said corresponding data, and wherein said linking comprises analyzing said priority at prior intervals during at least one prior time period.

24. The method of claim 17, wherein said prioritizing results in grouped data storage resource allocation prioritization for data grouped from disperse storage locations within the system irrespective of physical data storage proximity and data access recency.
